(19) United States
(12) Patent Application Publication
(10) Pub. No.: US 2012/0129544 A1
(43) Pub. Date: May 24, 2012

(54) SYSTEMS AND METHODS FOR SELECTIVELY INVOKING POSITIONING SYSTEMS FOR MOBILE DEVICE CONTROL APPLICATIONS USING ACCELEROMETER MEASUREMENTS

(75) Inventors: Mordechai Hodis, Framingham, MA (US); Oren Kagan, Chestnut Hill, MA (US)

(73) Assignee: Illume Software, Inc., Newton, MA (US)

(21) Appl. No.: 12/950,579

(22) Filed: Nov. 19, 2010

(51) Int. Cl. H04W 48/04; H04W 64/00

(52) U.S. Cl. 455/456.1

(57) ABSTRACT

Systems and methods are provided for controlling a mobile device, in which a processor receives a first accelerometer signal representative of motion of the mobile device. The processor determines a variation in the first accelerometer signal, and sets an acceleration threshold based at least in part on the determined variation. When a second accelerometer signal exceeds the acceleration threshold, the processor measures a position of the mobile device using a positioning system, determines that a user of the mobile device is likely in control of a vehicle, and disables one or more mobile device features.

### BACKGROUND OF THE INVENTION

The problem of mobile devices being used by people while operating vehicles is well-known. Drivers become distracted by these devices, and are at a higher risk of being involved in a driving-related incident. As discussed in co-pending U.S. patent application Ser. No. 11/956,067, filed Dec. 13, 2007, one useful approach to mitigating this problem involves monitoring the speed at which a mobile device is traveling. When the mobile device is in transit (typically determined by comparing the speed of the mobile device to a predetermined threshold), access control messages are transmitted either by the mobile communications device itself or a vehicle associated with the mobile device. The access control messages indicate to the mobile device communications network that communication with the mobile communications device should be prevented or deflected until the mobile device is no longer in transit. Another useful approach is described in co-pending U.S. patent application Ser. No. 12/040,581, filed Feb. 29, 2008, which includes a mobile phone-based system for disabling a cellular phone when the phone is known to be moving at a predetermined speed. These co-pending applications are incorporated by reference herein in their entireties.

In some embodiments of the mobile device control technologies described in the above pending applications, positioning systems, such as GPS, are used to determine where the mobile device is located and/or how fast the mobile device is moving. Such positioning systems typically have high power requirements. Consequently, when these systems are included within a battery-powered mobile device, the battery is quickly drained, especially when the positioning system is operated continuously or frequently. Additionally, many such systems rely on a line-of-sight communication path between the mobile device and a satellite or other transmitter. When the mobile device is being used indoors, or in urban areas, no sufficient communication path may exist. To mitigate power consumption, other less “power hungry” motion detection devices are sometimes used. For example, the location technique described by Horvitz et al. in U.S. Patent Application Publication No. 2007/0005243, published Jan. 4, 2007, only turns on the GPS when an accelerometer indicates that, for example, “the velocity of a user is seen to decelerate from 60 miles per hour to 40 to 30 to 10 to 5 to 2 miles per hour.” In the examples described by Gopinath in U.S. Patent Application Publication No. 2009/0278738, published Nov. 12, 2009, microelectromechanical devices, such an accelerometer or gyroscope, are used to determine relative positions (instead of using GPS to obtain absolute positions).

### SUMMARY OF THE INVENTION

Applicants have identified a number of shortcomings of existing mobile device control technologies, which are addressed by the systems and methods disclosed herein. In particular, existing technologies fail to address the variations between different devices and uses of those devices. For example, any of a number of different mechanical attachment techniques may be used to mount an accelerometer to a mobile device, each of which may have different damping properties that affect the accelerations detected by the accelerometer when the device undergoes routine handling. When a single, predetermined acceleration rule is applied to all of these different devices, the result is likely to be less than satisfactory for all of them. In another example, some users carry their mobile devices with them while jogging, and an accelerometer within such a device may register frequent periods of acceleration when the user's foot impacts the ground. If each of these accelerations triggers a GPS reading or a speed calculation, the utility of the mobile device control technology is undermined and the operating time reduced.

To address these and other shortcomings of existing mobile device control technologies, systems and methods are provided herein for controlling a mobile device in motion while reducing power consumption of positioning systems such as GPS. In particular, the systems and techniques described herein intelligently identify the points in time at which it is particularly advantageous to make a position measurement by automatically classifying accelerometer readings to distinguish vehicular travel from non-vehicular travel.

In one aspect, a method is provided for controlling a mobile device. A processor receives a first accelerometer signal representative of motion of the mobile device, and determines a characteristic variation in the first accelerometer signal. In some embodiments, the first accelerometer signal includes a plurality of discrete accelerometer signals at approximately periodic points in time. In some embodiments, the processor determines a characteristic variation by calculating a deviation from a central value of the accelerometer signals (such as a mean). The processor sets an acceleration threshold based at least in part on the characteristic variation. In some embodiments, an absolute value of the acceleration threshold is greater than or equal to the characteristic variation. The processor then compares a second accelerometer signal to the acceleration threshold. The second accelerometer signal may be a portion of the first accelerometer signal. When the second accelerometer signal exceeds the acceleration threshold, a position of the mobile device is measured using a positioning system (such as a GPS system) and the processor determines whether a user of the mobile device is likely in control of a vehicle. When the processor determines that the user is likely in control of a vehicle, the processor disables one or more mobile device features. When the processor determines that the second accelerometer signal does not exceed the acceleration threshold, the processor may enable one or more features of the mobile device.

In some embodiments, the processor identifies one or more portions of the first accelerometer signal that are determined to have smaller variations than other portions of the first accelerometer signal. In some such embodiments, the processor determines a characteristic variation in the first accelerometer signal by determining a characteristic variation in the identified one or more portions of the first accelerometer signal that are determined to have smaller variations. In some embodiments, an absolute value of the acceleration threshold is less than or equal to a maximum of an absolute value of a small variation portion of the first accelerometer signal. In some embodiments, the processor determines the characteristic variation by analyzing portions of the first accelerometer signal received when the mobile device is not traveling in a vehicle. The processor may set the acceleration threshold by analyzing portions of the first accelerometer signal received when the mobile device is traveling in a vehicle. In some embodiments, the processor compares the second accelerometer signal to the acceleration threshold by comparing the absolute value of the second accelerometer signal to the absolute value of the acceleration threshold. In some embodiments, the processor sets the acceleration threshold by receiving a plurality of acceleration signals over two or more days, identifying a pattern within the plurality of acceleration signals received over two or more days, and selecting a value for the acceleration threshold based at least in part on the identified pattern.

In some embodiments, the processor determines whether a user of the mobile device is likely in control of a vehicle based at least in part on the measured position. For example, the processor may determine that the mobile device has traveled beyond a predetermined distance in a particular amount of time. In a second example, the processor compares a speed of the mobile device to a speed threshold. In a third example, the processor detects a signal from a vehicle.

In another aspect, a method is provided for controlling a mobile device. A processor receives an accelerometer signal representative of the motion of the mobile device and compares the accelerometer signal to an acceleration threshold stored in a memory. When the comparison indicates that the accelerometer signal exceeds the acceleration threshold, a position of the mobile device is measured using a positioning system. The processor uses the position measurement to determine whether a user of the mobile device is likely in control of a vehicle, and in response to determining that the user is likely in control of a vehicle, the processor disables one or more features of the mobile device.

In another aspect, a system is provided for controlling a mobile device, including a control unit configured to receive a first accelerometer signal representative of motion of the mobile device, determine a characteristic variation in the first accelerometer signal, set an acceleration threshold based at least in part on the characteristic variation, and compare a second accelerometer signal to the acceleration threshold. When the second accelerometer signal exceeds the acceleration threshold, the control unit is configured to measure a position of the mobile device using a positioning system and determine whether a user of the mobile device is likely in control of a vehicle. When the user is likely in control of a vehicle, the control unit is configured to disable one or more mobile device features. In another aspect, a system is provided for controlling a mobile device, including a control unit configured to receive an accelerometer signal representative of the motion of the mobile device and compare the accelerometer signal to an acceleration threshold stored in a memory. When the accelerometer signal exceeds the acceleration threshold, the control unit is configured to measure a position of the mobile device using a positioning system and determine whether a user of the mobile device is likely in control of a vehicle, based at least in part on the measured position. When the user is likely in control of a vehicle, the control unit is configured to disable one or more mobile device features.

### BRIEF DESCRIPTION OF THE DRAWINGS

The above and other objects and advantages of the systems and methods of the present disclosure will be apparent upon consideration of the following detailed description, taken in conjunction with the accompanying drawings, in which like reference characters refer to like parts throughout, and in which:

FIG. 1 is a block diagram of a mobile device configured to selectively permit its use;

FIG. 2 is a block diagram of a network-centric system for controlling permitted use of a mobile device;

FIG. 3 is a block diagram of a vehicle-centric system for controlling permitted use of a mobile device;

FIG. 4 is a block diagram of an alternative vehicle-centric system for controlling permitted use of a mobile device for use in the system of FIG. 3;

FIG. 5 is a flow chart of a method of restricting use of a mobile device;

FIG. 6 is a flow chart of a method of generating or updating a mobility access profile;

FIG. 7 is a flow chart of a method of selectively permitting use of a mobile device;

FIG. 8 is a flow chart of a method of selectively invoking a positioning system using multiple non-position-based sensors;

FIG. 9 is a flow chart of a method of indicating motion of a mobile device using a variation in accelerometer signals;

FIG. 10 depicts an example accelerometer waveform to illustrate several techniques that may be used to determine the variation in accelerometer signals in accordance with the method of FIG. 9;

FIG. 11 is a flow chart of a method of indicating motion of a mobile device using electronic compass signals;

FIG. 12 is a flow chart of a method of indicating motion of a mobile device using measurements of wireless networks in an environment of the mobile device;

FIG. 13 depicts an illustrative mobile device motion scenario to which the method of FIG. 12 is usefully applied;

FIG. 14 is a schematic representation of measurement data representative of wireless networks in the mobile device motion scenario of FIG. 13, in accordance with an embodiment; and

FIG. 15 is a schematic representation of measurement data and positioning system availability data in accordance with an embodiment.

### DETAILED DESCRIPTION

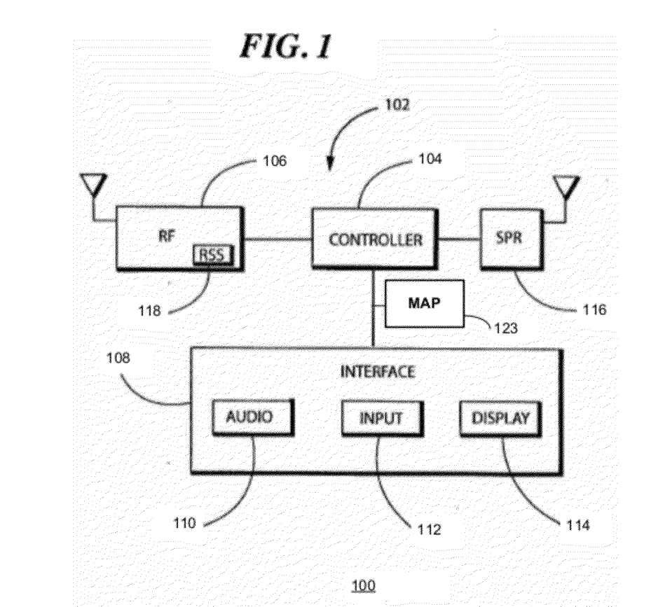

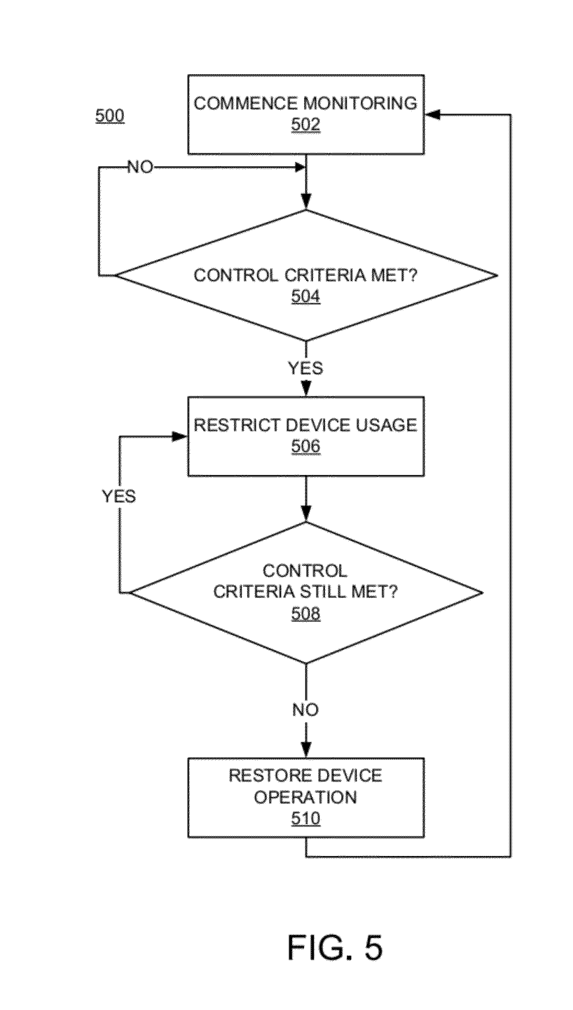

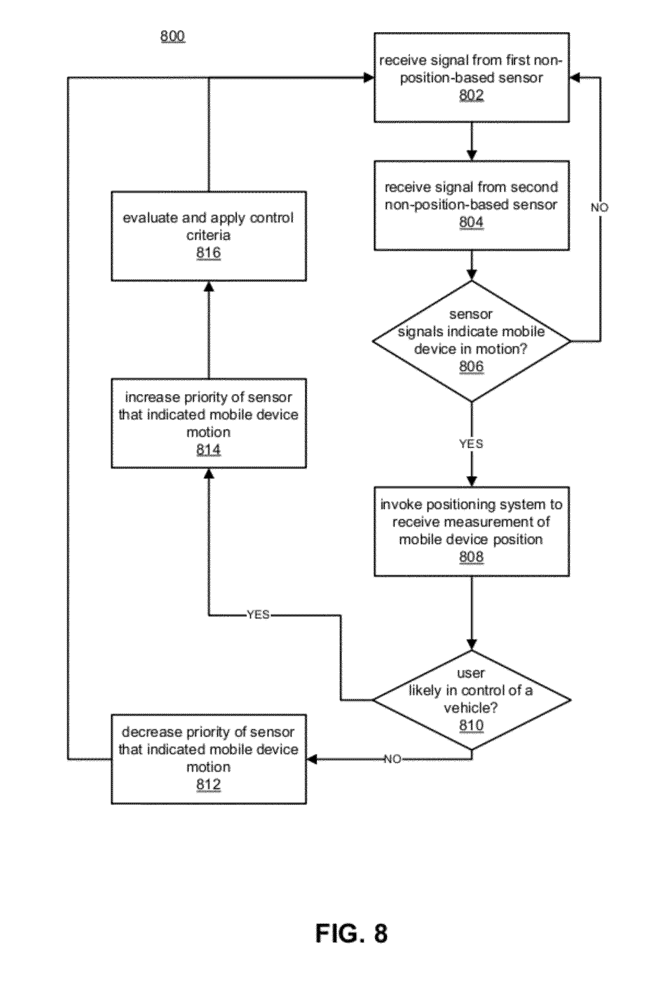

Described herein are systems and methods for selectively permitting use of a mobile device while the device is in motion. As used herein, “motion” of the mobile device may refer to any information regarding the context and movement of the mobile device, an associated vehicle and/or its user such as physical displacement, a geographic location, bearing, speed or acceleration. These systems and methods can be implemented in a number of different configurations. Several exemplary configurations are discussed below with reference to FIGS. 1-4. These configurations are not mutually exclusive, and it is anticipated that elements from each may be combined and still fall within the scope of the invention. After discussing the exemplary configurations of FIGS. 1-4, techniques that may be implemented in accordance with different embodiments are discussed with reference to FIGS. 5-7. Finally, techniques for selectively invoking a positioning system are discussed and illustrated with reference to FIGS. 8-14.

FIG. 1 depicts a “mobile-centric” configuration in which control of a mobile device is at least partially exerted by a controller included in the mobile device itself. The mobile device could be a cellular telephone, personal digital assistant, two-way pager, portable media player, laptop or notebook computer, or any other mobile communication or information device.

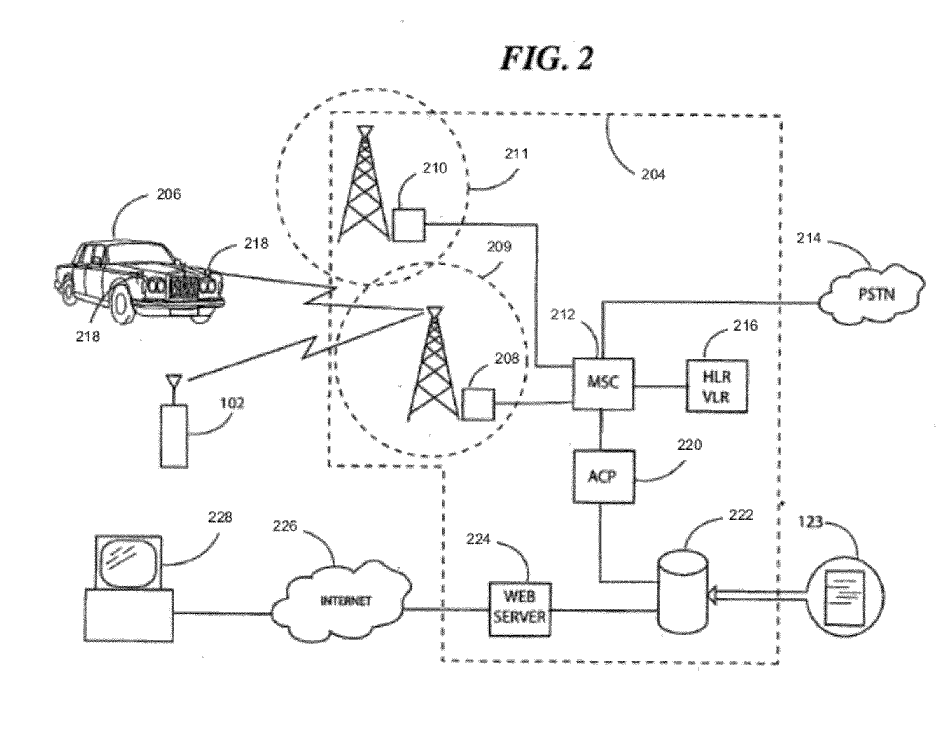

In particular, FIG. 1 is a block diagram of an illustrative mobile device 102, which includes a controller 104 for controlling operation of the mobile device 102. A radio frequency transceiver 106 provides radio access between the mobile device 102 and a communication system 204 (discussed below with reference to FIG. 2). The mobile device 102 also includes a user interface 108 so that the user of the mobile device 102 can interact and control the operation of the device 102.

The controller 104 is described herein as a general purpose processor included in the mobile device 102 that has been programmed with software (i.e., one or more modules of computer executable instructions) configured to perform the monitoring and control techniques described herein. The software may be a downloadable application (e.g., one that can be purchased from an online source and transmitted to the mobile device 102). Alternatively, the controller 104 may be implemented via any combination of hardware, firmware, and software executing on a general purpose processor.

The user interface 106 includes interface elements such as an audio element 110, an input element 112, and a visual display element 114. The audio element 110 may include a microphone and speaker, and other audio transducers for generating alerts, music, audible messages and ringing sounds. The input element 112 may include, for example, a keypad, a software-based graphical user interface, a mechanical or optical mouse or trackball, a touch screen, voice recognition components, or other button/entry elements. The visual display element 114 may include, for example, a graphical display such as a liquid crystal display.

The mobile device 102 may use any of a number of techniques to determine that it is moving at a sufficient speed to indicate that is in a vehicle, or is in some other condition under which use of the mobile device 102 should be selectively permitted or restricted. For example, in a cellular communication application, the controller 104 may track the received signal strength indicator (RSSI) 118 of nearby serving cells (such as the serving cell 209 and the neighbor cell 211 of the mobile device support system 200 of FIG. 2). If the signal strength changes at a sufficiently rapid rate, it may be used as an indication that the mobile device 102 is in transit. In another example, the detection by the controller 104 of a handover between serving cells may be used as an indication that the mobile device 102 is in transit. Another method that may be employed leverages the presence of a satellite-positioning information receiver 116 (such as a GPS receiver) in the mobile device 102 to determine. The controller 104 may also detect motion using an embedded accelerometer, an anemometer, a ground-based positioning system, or by monitoring changes in the mobile device's environment (such as changes in atmospheric pressure, acoustic changes such as the Doppler effect, or changes in local scenery detected using known computer vision algorithms). By tracking location and time, for example, the controller 104 can make a number of determinations about its motion, as described in detail below.

Upon determining that the mobile device 102 is in transit, the controller 104 processes data indicative of the device's movement to determine whether usage of the device should be restricted. In one embodiment, such processing includes comparing the motion information to data stored in a mobility access profile (“MAP”) 123 stored therein. The MAP 123 is a file or record including information for setting the permitted uses of the mobile device 102. The MAP 123 may be stored or recorded in any suitable format or data structure. The MAP 123 includes two types of information about the mobile device 102: control criteria and permitted use parameters. Control criteria are criteria against which the motion of the mobile device 102 is compared to determine what operations and functions of the mobile device 102 should be enabled, disabled, or restricted. Each set of control criteria may be associated with a set of permitted use parameters. During use, controller 104 compares the motion of the mobile device 102 against the control criteria of the MAP 123 and applies the permitted use parameters associated with any control criteria that are met.

As a result, certain functions of the mobile device 102 may be modified or restricted; for example, the controller 104 may deny call setup requests; prohibit peer-to-peer and text messaging, Internet access, camera functionality, gaming applications, or the like; route incoming calls to a voice mail account associated with the mobile device 102 or provide a busy signal; divert an incoming communication to an e-mail, voicemail or other communications medium, or otherwise modify any other mobile device function or feature, or any combination thereof. In some implementations, calling and/or receiving one or more specific phone numbers, such as an emergency number, a home number or a parent's cellular phone number, or a dispatcher or supervisor's number, may be allowed while all other call setup requests are blocked. In some implementations, enforcing the permitted use parameters includes the controller 104 shutting off, blocking, or inhibiting certain interface elements, such as the elements 110, 112 and 114 (FIG. 1). Disabling interface elements advantageously reduces user interaction with the mobile device 102; by doing so, a user is prevented from, for example, composing a text message on the mobile device 102, only to discover that the messaging service has been restricted upon trying to send the message. By disabling the text messaging interface elements, the user is not allowed to compose a message in the first place, thus preventing use of the mobile device 102 while in transit. The same methodology can be used to block voice messaging, web browsing, or any other mobile device function.

FIG. 2 depicts a “network-centric” configuration in which control of a mobile device is at least partially exerted by a remote communication system in contact with the mobile device. In particular, FIG. 2 depicts a mobile device support system 200, which includes the mobile device 102, and a communication system 204 that enables communication to and from the mobile device 102. A user of the mobile device 102 may use a vehicle 206 to drive to various destinations. The communication system 204 includes a base station 208, which provides a radio-air interface to subscribing mobile devices (such as the mobile device 102) in the vicinity of the base station 208. The region over which the mobile device 102 exchanges information with the base station 208 is the serving cell 209. The mobile device 102 may travel to other cells, and the communication system 204 will hand over communication service to each new serving cell as the device changes cell affiliation, as is well known in the art. A nearby base station 210 and its associated cell 211 are referred to as a neighbor cell. Quite often, even though the mobile device 102 is affiliated with the serving cell 209, the mobile device 102 can receive and measure signals from the neighbor cell 211 to determine, for example, when to make a handover or for reporting to the communication system 204, which may determine when a handover is needed.

In some mobile communications applications, the base stations 208 and 210 serve as intermediaries between the mobile device 102 and a mobile switching center (MSC) 212. The MSC 212 controls calling and other communication activity, and is connected to a public switched telephone network (PSTN) 214. The MSC 212 sets up communication circuits for various modes of communication, in accordance with request and authorization protocols as known in the art. The MSC 212 controls communication access for subscribing and authorized roaming mobile devices (such as the mobile device 102) in accordance with a home location register and visit location register (HLR/VLR) 214. The HLR/VLR 214 maintains subscriber information and other parameters relating to mobility management, access control, and so on, which governs the manner in which the mobile device 102 operates within the communication system 204.

In certain implementations, the communication system 204 is informed of the apparent travel of the mobile device 102. The communication system 204 may be informed from any one of at least two sources. First, the mobile device 102, itself, may report to the communication system 204 that the mobile device 102 appears to be traveling. Second, a vehicle module 218 disposed in vehicle 206 may report to the communication system 204 when the vehicle 206 is being operated or is traveling. The monitoring of the mobile device 102 or the vehicle 206 is performed continuously, periodically, or aperiodically.

When the mobile device 102 is in transit, the communication system 204 receives an access control message (ACM). An ACM is an information signal which includes information regarding the mobile device 102, such as its position, velocity, relative position with respect to a communications cell, relative position with respect to a beacon or marker, geographical coordinates, bearing, acceleration, altitude, or information derived from one or more thereof (such as rates of change, higher-order derivatives, and statistical measures like averages, standard deviations, and medians). The ACM is created by the mobile device 102, the vehicle module 218, the base station 208 or 210, or by another component of the mobile device support system 200 used to determine movement of the mobile device 102 or the vehicle 206 (as discussed in other implementations below). In some implementations, the ACM also includes identifying information about the user, the mobile device 102 or the vehicle 206, such as a communication address for the mobile device 102 or the vehicle 206 (i.e., a telephone number, an IP address, an e-mail address). Utilizing this information, the ACM enables the MSC 212 to determine whether or not the communication circuit needs to be reconfigured to selectively permit use of the mobile device 102 while the device is in motion.

The MSC 212 recognizes the ACM and routes it to an access control processor (ACP) 220 as a function of the information contained in the ACM. The ACP 220 then accesses an access database 222 to retrieve a MAP 123, (e.g., a cellular system mobility access profile (MAP)) stored therein. As described above, the MAP 123 includes control criteria and permitted use parameters for a given user. The ACP 220 provides the information in the MAP 123 to the MSC 212, which then applies the permitted use parameters associated with the mobile device 102. More particularly, access to communication resources of the communication system 204 by the mobile device 102 is selectively permitted by comparing the motion of the mobile device 102 or the vehicle 206 to the control criteria stored in the MAP 123. The communication system 204 may, for example, deny call setup requests, peer-to-peer and text messaging usage, Internet access; route incoming calls to a voice mail account associated with the mobile device 102; provide a busy signal upon receipt of an incoming call; divert an incoming communication to an e-mail, voicemail or other communications address, and so on as a function of the permitted use parameters stored in the MAP 123 and processed by the MSC 212 and the ACP 220. The communication system 204 may further allow exceptions to any restrictions imposed. For example, calling or receiving calls from one or more specific phone numbers, such as an emergency number, a home number or a parent's cellular phone number, a dispatcher, or supervisor, may be allowed while all other call setup requests are blocked. In some implementations, generic instructions to allow all emergency calls (911, for example), may be executed by default at the MSC 212 or the ACP 220. This methodology applies whether the mobile device functions are triggered by actions originating at the mobile device 102 (e.g., outgoing calls) or are aimed at the mobile device 102 (e.g., incoming calls). Note that if a profile for the mobile device 102 associated with the generated ACM does not exist in the access database 222, then the user or another authorized party (such as the user's parent) may be notified by e-mail or an Internet site and a MAP may be created for a particular mobile device.

Once the information in the MAP 123 is provided to the MSC 212, the MSC 212 then updates the present permitted use parameters associated with the mobile device 102. The present permitted use parameters may be stored, for example, in the VLR 214, and may be accessed by the MSC 212 when the mobile device 102 requests communication resources, or when incoming communications are received which are bound for the mobile device 102.

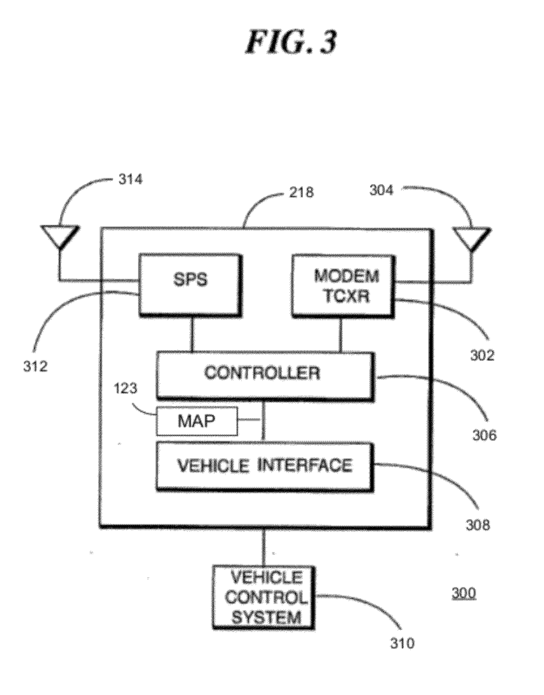

FIG. 3 depicts a “vehicle-centric” configuration in which control of a mobile device is at least partially exerted by a vehicle-mounted control system in communication with the mobile device. In particular, FIG. 3 is a block diagram of a vehicle-mounted control system 300. The vehicle-mounted control system 300 includes a vehicle module 218 for use in selectively permitting use of the mobile device 102. The vehicle module 218 is mounted in the vehicle 206. The vehicle module 218 determines that the vehicle 206 is in motion and/or is being operated. In some implementations, the vehicle module 218 has a modem 302, which includes a radio frequency transceiver capable of accessing the communication system 204 of FIG. 2 via an antenna 304. In these implementations, the vehicle module 218 may transmit an access control message (ACM) to the communication system 204 (and specifically to the ACP 220 or its functional equivalent as discussed above). The modem 302 may act as another subscribing device in the communications system 204 and use the same wireless interface to the communications system 204 as the mobile device 102. Alternatively, the modem 302 may use an alternative wireless interface to the communications system 204. The modem 302 operates under control of a vehicle controller 306, which is programmed to carry out operations such as creating an ACM.

In other implementations, the vehicle module 218 may use the modem 302 (or other communication device) to transmit an ACM or other communication including motion data directly to the mobile device 102, instead of transmitting such information to the communications system 204. In such implementations, the mobile device 102 is configured to receive messages regarding the motion of the vehicle 206 and use its own internal hardware and software (e.g., a controller similar to controller 104 of FIG. 1) to compare the motion of the vehicle 206 to one or more sets of control criteria (e.g., a MAP similar to MAP 123), and adjust the permitted uses of the mobile device 102 accordingly.

In some implementations, the vehicle controller 306 is interfaced though a vehicle interface 308 (e.g., via a cable connected to an OBD-compliant data port) to the vehicle control system 310. The vehicle control system 310 is the system in the vehicle 206 that controls, for example, instrumentation, engine operation, diagnostics, and other vehicle operation and monitoring functions. The vehicle control system 310 may be configured to provide information to the vehicle controller 306 as, for example, vehicle speed, vehicle access, the identity of a specific key or other access device used to operate the vehicle, and so on. The vehicle module 218 may use this information to determine when to transmit an ACM or motion information message, and what the contents of the ACM are to be. For example, when the vehicle speed reaches a preselected threshold, or if a key associated with a restricted user is used to access and operate the vehicle 206, the vehicle module 218 may transmit an ACM or other motion information message to the mobile device.

In some implementations, the vehicle module 218 may operate independently of the vehicle control system 310 and determine use of the vehicle by other means, such as, for example, a satellite positioning system receiver 312, which receives positioning signals from positioning satellites via an antenna 314. By using position information, the vehicle controller 306 can determine when the vehicle is moving, at what speed and subsequently transmit the ACM or other motion information message. Other means of triggering the transmission of an ACM may be used, such as pairing the vehicle module 218 with the mobile device 102 via a personal area network link. The vehicle module 218 may be installed such that pairing the mobile device 102 with the vehicle module 218 is required before the vehicle module 218 allows the vehicle 206 to start, for example, by using the personal area network media access information of the mobile device 102 as a sort of key.

The vehicle module 218 may, upon installation in the vehicle 206, be programmed with information to identify the mobile device 102 to the ACP 220 of the communications system 204 (discussed above with reference to FIG. 2). For example, an international mobile subscriber identifier (IMSI) or simply the phone number assigned to the mobile device 102 may be used. An identifier of the vehicle module 218 may be associated with the mobile device 102 at the ACP 220 and, when the ACP 220 receives the access control message, the ACP 220 cross references the vehicle module identifier with the identity of the mobile device 102 to locate the appropriate MAP 123 corresponding to the mobile device 102.

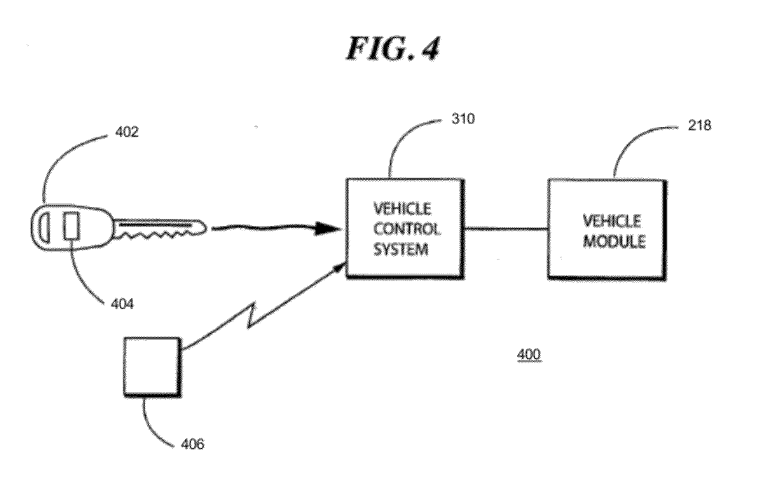

FIG. 4 depicts a second “vehicle-centric” configuration in which control of a mobile device is at least partially exerted by a vehicle-mounted control system in contact with the mobile device. In particular, FIG. 4 is a block diagram of a vehicle system 400 based on the vehicle system 300 for selectively permitting use of the mobile device 102 in accordance with another embodiment. In the vehicle system 400, the vehicle module 218 is interfaced with the vehicle control system 310. The vehicle control system 310 may detect the use of a key 402 to access and operate the vehicle 206. Automobile manufacturers routinely design a standard key and a valet key, for example. Manufacturers may likewise provide a “teen” key 402 to be used by a young family member to access and operate the vehicle 206. The key 402 is used by the person who also uses the mobile device 102, which is to be restricted upon operation of the vehicle 206. In addition to, or instead of the key 402 having a unique mechanical configuration, the key 402 may be provided with a memory element 304, which contains a unique identifier recognized by the vehicle control system 310 as one that is authorized to operate the vehicle.

In some implementations, a wireless key 406 may be used to access the vehicle 206 (instead of or in addition to the key 402). The wireless key 406 may transmit a code to the vehicle control system 310 over a short-range wireless link. This causes the vehicle control system 310 to cause the vehicle module 218 to transmit an ACM as discussed above (e.g., to the communications network 104 or the mobile device 102). In certain implementations, the mobile device 102 is itself configured as a wireless key (such as the wireless key 406), using a personal area network interface such as that known in the industry by the trade name Bluetooth™, for example.

FIG. 5 is a flow chart of a method for selectively permitting the use of a mobile device. The steps of the flow charts of FIGS. 5-9 and 11-12 are described as being performed by a “processor,” which may be any suitable electronic processor included in the mobile device 102, the vehicle systems 300 or 400, or the mobile device support system 200 (FIG. 2) described above, or any combination thereof. For example, the steps depicted in any of FIGS. 5-9 and 11-12 may be performed by the controller 104 included in mobile device 102, or by an MSC 212. Additionally, the steps depicted in any of the flow charts of FIGS. 5-9 and 11-12 may be distributed between two or more processors, which may perform their operations in parallel or in series.

FIG. 5 is a flow chart 500 of a method of restricting use of a mobile device. At Step 502, a processor commences monitoring the motion state of a mobile device, such as mobile device 102. The processor may begin the monitoring upon a user powering up the mobile device 102, upon the mobile device 102 exiting a sleep state, upon launch of a separate software application stored in memory on mobile device 102, or upon detection by the mobile device 102 of a signal indicative of the device being within a vehicle (for example, receiving a message from a vehicle module 218 indicating the proximity of a key 402 or 306). Monitoring includes, without limitation, determining by any suitable means whether control criteria stored in a mobility access profile (MAP) (either stored on the device or stored remotely) have been met. For example, the processor monitors whether the device is moving at a rate above a threshold speed. Additional or alternative control criteria may include, without limitation, location within a given governmental jurisdiction having restrictions on mobile device usage, and time of day. These determinations can be made in any suitable fashion, including by making various analyses described above in relation to FIG. 1. In implementations of the method involving remote enforcement of permitted use parameters, the mobile device regularly, or on an event-driven basis, forwards data it collects from monitoring to the MSC 212 in an ACM.

At decision block 504, the processor determines whether any of the control criteria has been met. As indicated above, this determination can be made by the mobile device controller 104 or by the MSC 212, or a combination of the two. The determination could also be made by the vehicle module 218. Upon determining that sufficient control criteria have been met to justify limiting mobile device functionality, the mobile device 102 and/or the MSC 212 begin enforcing the permitted use parameters described above (Step 506).

The processor continues to monitor the motion of the mobile device (Step 508). Upon a determination that sufficient control criteria sufficient to restrict device usage are no longer met, the mobile device 102 and/or MSC 212 restores full device operation (Step 510).

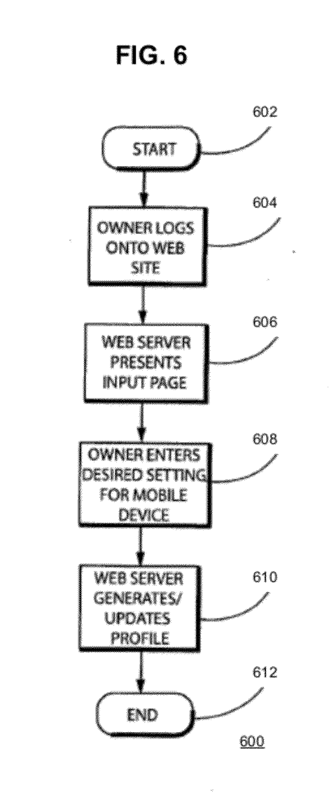

FIG. 6 is a flow chart 600 of a method for generating or updating a mobility access profile (MAP) (such as MAP 123 of FIGS. 1, 2 and 3). At Step 602, a processor provides Internet access to a web server 224 (FIG. 1) to allow users and owners of mobile devices (such as the mobile device 102) to enter and edit information in mobility access profiles (such as MAP 123). At Step 604, a user, owner, or otherwise authorized party logs onto the web server 224 via an Internet connection 126 (FIG. 1). Examples of authorized parties include parents, managers, guardians, supervisors, law enforcement officials, insurance agents and other appropriate individuals or organizations. At Step 606, the web server 224 provides a web page or web pages requesting user input to establish settings and control criteria to be used as the parameters in adjusting the permitted uses of the mobile device 102. At Step 608, the user or other party enters the information, and by way of non-limiting example, may include the identity of the mobile device 102, a phone number assigned to the mobile device 102, the identity of the vehicle module 218, and one or more allowed phone numbers which will not be restricted. Emergency service numbers may be allowed by default, and may be updated by the user. At Step 610, the web server 224 uses the information to generate or update the MAP 123 (e.g., in the memory embedded in the mobile device 102, or the access database 222 of the communication system 204 of FIG. 1). At Step 612, the user may log off or otherwise terminate their session.

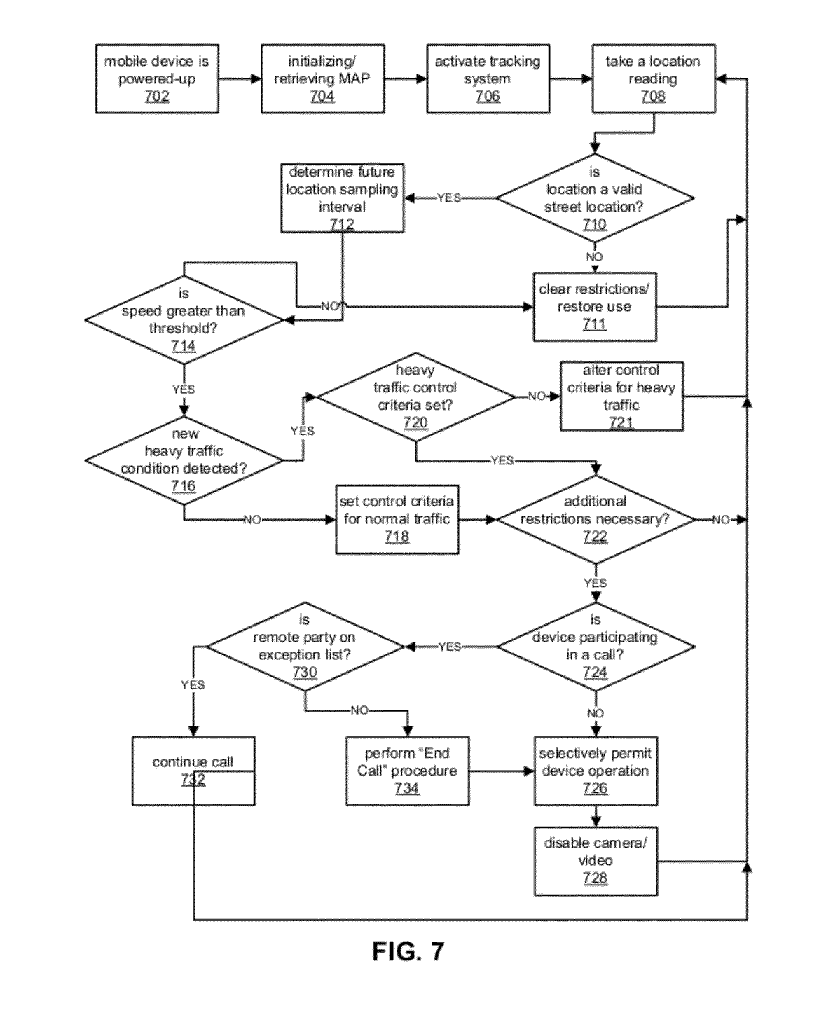

FIG. 7 is a flow chart describing techniques for selectively permitting use of a mobile device. Some such techniques are described in U.S. patent application Ser. No. 12/890,347, filed Sep. 24, 2010, incorporated by reference herein in its entirety. by Fernandez et al. in U.S. patent application Ser. No. 12/890,347, “Systems and Methods for Altering Control Criteria for Mobile Device Operation,” filed Sep. 24, 2010 and incorporated by reference herein in its entirety. The techniques illustrated by FIG. 7 improve upon existing technologies in many ways; in particular, by altering control criteria in response to the variation of the speed of the mobile device. Several implementations of this technique are described in the discussion of FIG. 7 below.

At Step 702, the mobile device 102 is turned on, powered up or “awoken” from a sleep or hibernation mode. At Step 704, settings regarding operation of the mobile device 102 are initialized or retrieved from the MAP 123 (which may be stored in the communications system 204, the vehicle module 218, and/or the mobile device 102). These settings may be initialized to a default value (e.g., at the time of manufacture or sale), customized according to user preferences or local laws, or entered as part of HLR/NLR 214 or MAP 123 by the user (see e.g., the discussion of FIG. 6, above).

At Step 706, a processor activates a tracking system. The tracking system may be located in the mobile device 102, the vehicle module 218, the communications system 204, or distributed between two or more of these components. In certain implementations, the tracking system is a position tracking system included in the mobile device 102. In preferred implementations, the tracking system is a global positioning system (GPS) that is configured to determine the position of the mobile device 102. In some implementations, the tracking system is a position tracking system included in the vehicle module 218 (e.g., a GPS system). In certain implementations, the tracking system is a speed monitoring system that does not necessarily rely on position measurements (e.g., an accelerometer-based or signal strength tracking system). In the following discussion, GPS is used as the tracking system by way of non-limiting example to facilitate discussion, but non-GPS and non-position-based tracking systems may be used to implement the heavy traffic detection and response techniques described here. In implementations that do not include position-based tracking systems, the steps of the flow diagrams of FIG. 7 that include a position-based activity may be omitted and remain within the scope of the disclosure.

At Step 708, the processor receives a GPS reading indicative of the position of the mobile device 102. At decision block 710, the processor compares the GPS reading to a map stored in a memory accessible to the processor. Such maps are provided by Internet-based technologies including MAPQUEST and Google Maps, and can be downloaded to the memory in advance of decision block 710 or in conjunction with decision block 710 based on the GPS reading. This memory may be local or remote. Comparing the GPS reading to the stored map allows the processor to determine whether the mobile device 102 is positioned at a valid street location. If the position of the mobile device 102 is not a valid street location, then it is likely that the user of the mobile device 102 is not driving a vehicle (e.g., the user is on a train, or walking at an off-street location) and thus restricted use of the mobile device 102 is not required. In this case, the processor executes a “clear” Step 711 and sends an unlock software control signal to the mobile device 102 to reset any software locks that were set previously (discussed below), then executes Step 708 again to take further GPS readings until it is determined that the mobile device 102 is located at a valid street location.

At decision block 710, if the processor determines that the mobile device 102 is in a valid street location, a second GPS reading is received at Step 712. This second GPS reading is taken at a predetermined time interval from the first GPS reading (received at Step 708), and can be used in to determine the speed of motion of the mobile device 102 by dividing the distance traveled between the first and second GPS readings by the duration of the time interval. As discussed above with reference to FIGS. 5 and 6, information about the motion of the mobile device 102, including its speed, is compared against the control criteria stored in MAP 123. In preferred implementations, the MAP 123 is stored at the mobile device 102. At decision block 714, the processor determines whether the motion of the mobile device 102 satisfies a set of control criteria which will require a change in the permitted uses of the mobile device 102. For example, the control criteria may include a safe speed threshold for the mobile device. This safe speed threshold may be a predetermined speed above which safe operation of the mobile device 102 is impaired. When the mobile device 102 is moving at a speed below the safe speed threshold of the control criteria, the processor executes a “clear” Step 711, then returns to

Step 708 and continues to take GPS readings to monitor the motion of the mobile device 102.

If the processor determines at decision block 714 that the speed of the mobile device 102 exceeds the safe speed threshold, the processor performs a heavy traffic detection technique at decision block 716. If the processor determines that the mobile device 102 is not in heavy traffic at decision block 716, then the control criteria are set to (or maintained at) their “normal traffic” values at Step 718, and the processor proceeds to decision block 722 (discussed below). However, if the processor determines that the mobile device 102 is in heavy traffic, the processor assesses whether the current control criteria are set to their heavy traffic values at decision block 720. If not, the control criteria are altered to their heavy traffic values at Step 721. Heavy traffic detection techniques are discussed in detail below, as are the techniques performed at Step 721 when a heavy traffic condition is detected. After the heavy traffic condition is detected and responded to (if necessary), the processor determines at decision block 722 whether the permitted uses of the mobile device 102 are to be changed as a result of the excessive speed detected at decision block 714. If the use of the mobile device 102 is already appropriately restricted (e.g., because the mobile device 102 has previously exceeded the safe speed threshold), the processor returns to execute Step 708 and receive another GPS reading.

If the use of the mobile device 102 is not appropriately restricted, the processor determines at decision block 724 whether the mobile device 102 is currently in use. For example, the user may be making use of the mobile device 102 to watch a video or send/receive a text message. If the mobile device 102 is not in use, the permitted use parameters are applied at Step 726 to the operation of the mobile device 102 to restrict or block operation. In some implementations, the permitted use parameters prevent access to the communication functions of the mobile device 102, and incoming calls are either re-routed, met with a busy signal, a voicemail message or the like as discussed above. The permitted use parameters may also cause the output of a software control signal to the mobile device 102 to “lock down” the keyboard and, in particular, a “send” button of the mobile device 102. At Step 728, the processor causes any camera capability of the mobile device 102 to be disabled. The permitted use parameters may also cause a software control signal to be transmitted to lock down access to the camera activation controls on the mobile device 102 and/or lock the display screen. The processor returned to Step 708 to take another GPS reading.

Returning to decision block 724, if the mobile device 102 is currently engaged in a voice communication, then the processor determines at decision block 730 whether or not the other party is on an exception list as stored in the MAP 123. The exception list includes phone numbers such as 911, for which the risk of using the mobile device 102 in transit is outweighed by the necessity to have such communications maintained. If the other party is on the exception list, then the communication session is allowed to continue at Step 732, and the processor returns to execute Step 708. If processor determines at decision block 730 that the other party is not on the exception list, then the restricted operation imposed by the permitted use parameters begins in order to ensure the safety of the user. Accordingly, at Step 734, the processor executes an “End Call” technique in which an “End Call” software signal generated by the mobile device 102 or the MSC 212 to activate the “hang-up” function of the mobile device 102. In this way, a communication session is ended without dropping the connection (i.e., the antenna is not turned off) and the stoppage of communication is handled as a normal “End Call,” not as a dropped call. In some implementations, the antenna may be turned off at Step 734, forcing an end to wireless communication with the mobile device 102.

In some implementations, rather than terminating an in-progress call or other audio communication, the processor may cause a disruptive noise (e.g., white noise, loud repeated beeps, automobile accident sounds, etc.) or an audible message (e.g., “PLEASE HANG UP. IT IS UNSAFE TO CONTINUE SPEAKING”) to be generated so that the user and/or the remote party can hear it. This noise or message may be repeated at a sufficient frequency, at a high enough volume, or otherwise be disruptive enough that it is very difficult for the user or remote party to continue the conversation, forcing one of the parties to manually end the call. The disruptive noise or message may persist for the duration of the audio communication, and may end when the audio communication ends, the mobile device 102 is no longer in transit, or both. The disruptive noise may be provided directly to communications circuitry within the mobile device 102, such as microphone circuitry and/or speaker circuitry. In some implementations, a web interface (e.g., the web interface for generating a mobility access profile described with reference to FIG. 6) is provided that allows mobile device users or other interested parties to select the disruptive signal from multiple possible disruptive signals, and/or record a custom sound or special message. For example, a user's child or spouse may record him or herself saying “Please think of our family, dear, and don't use the phone while you drive.” In some implementations, an interface for selecting and customizing the disruptive signal is provided on the mobile device 102 itself.

Once the communication session has ended, the remaining permitted use parameters are used to adjust the operation of the mobile device support system 200 at Step 726 (as described above). Adjusting the mobile device 102 in accordance with the permitted use parameters may include configuring the mobile device 102 to prevent communication with the communication system 204 by turning off the transmit side of the antenna circuitry of the mobile device 102, by locking the keyboard of the mobile device 102, or any of the other permitted use adjustments described herein. Adjusting the communications system in accordance with the permitted use parameters may include causing the communication system 204 to re-route calls to an on- or off-device voicemail repository, a forwarding phone number, an e-mail or alternate device, or providing a busy signal. In this way, incoming and outgoing communication functions may not be used by the user of the mobile device 102. After Step 728, at which the processor disables a camera included in the mobile device 102, the processor returns to Step 708 to take another GPS reading.

At Step 716, a heavy traffic detection and response technique is executed. In one implementation, the heavy traffic detection technique performed at Step 716 includes determining a variation of the speed of the mobile device 102. The speed variation may be determined by any one or more of the following exemplary techniques:
Counting a number of times in a first time interval that the speed of the mobile device 102 has increased above or decreased below a particular speed threshold (which may be the same as, or different than, the safe speed threshold). By way of example, if the threshold speed (e.g., 10 miles per hour) is crossed, either up or down, a predetermined number of times (e.g., 3) within a minute (or other predetermined time interval) then this would be an indicator that the vehicle 206 in which mobile device 102 is traveling is in heavy stop-and-go traffic. In certain implementations, the number of times that the mobile device 102 crosses the threshold speed is recorded at MSC 212,

ACP 220, HLR/NLR 214 (FIG. 1), the vehicle module 218, or at the mobile device 102 itself. At substantially the same time, a running clock is maintained within any suitable component to determine how often the threshold speed is crossed by the mobile device 102.
Determining an amount of time during which the speed of the mobile device 102 exceeds a particular speed threshold (which may be the same as, or different than, the safe speed threshold). This technique measures the consistency or “non-variation” of the speed, and is particularly useful for determining when a heavy traffic condition has abated, and the permitted uses of the device can be returned to their nominal settings. For example, if the speed is greater than 30 miles per hour for longer than one minute, the processor concludes that no heavy traffic condition exists.
Determining a distance traveled over a particular time interval by comparing a starting position and an ending position. This comparison allows the processor to distinguish a continuous travel situation that included intermediate accelerations (long distance traveled) from a stop-and-go travel situation (short distance traveled).
Receiving speed variation information regarding traffic local to the mobile device 102 from a source external to the mobile device 102 (e.g., a traffic website, news feed or Twitter feed). An online traffic monitoring sites may be queried by utilizing the web server 224 and Internet 226 (FIG. 1). If the tracking system activated at Step 1206 is a position-based tracking system (e.g., GPS, satellite, tower determination, etc.), the processor can use the location of the mobile device 102 to interrogate a traffic monitoring website to determine the existence of heavy traffic to be utilized as an input at decision block 716. In some implementations, the mobile device control criteria may be altered based on an average speed of traffic in the vicinity of the mobile device, the average speed of traffic at a particular time of day, or a notification of hazardous during conditions in the vicinity of the mobile device.
Monitoring accelerometer readings to identify frequent accelerations and decelerations. This technique may be performed by counting the peaks and valleys of the accelerometer signal or a velocity signal derived from the accelerometer signal, or applying a frequency-domain or wavelet-domain analysis technique to detect high frequency components in the acceleration signal, for example.

Another exemplary technique for determining a variation of the speed of the mobile device 102 includes determining a first representative speed of the mobile device 102 over a first interval of time, and determining a second representative speed of the mobile device 102 over a second interval of time. The first and second intervals of time may be contiguous or separate. A representative speed over an interval may be an average speed over the interval, a maximum speed over the interval, a minimum speed over the interval, or any other speed that represents the motion of the mobile device 102 over the interval. Once the first and second representative speeds have been determined, the variation of the speed of the mobile device 102 is measured by comparing the first and second representative speeds. In some implementations, this comparison is the ratio of the first and second representative speeds. In other implementations, this comparison is the absolute difference of the first and second representative speeds. In some implementations of this technique, the first and second representative speeds are only compared when at least one of them is greater than a predetermined threshold speed. In some implementations, both the first and second representative speeds when must be greater than a predetermined threshold speed before they are compared. The threshold speed may correspond to a walking speed, for example. By “discarding” representative speeds that are too slow to indicate travel in a vehicle, this implementation advantageously reduces the erroneous detection of a heavy traffic condition when a user is simply walking and occasionally stopping.

Any one or all of the above techniques may be utilized to determine a variation of the speed of the mobile device 102. In each technique, the determined variation is then compared to a threshold to determine whether the recorded speed pattern is indicative of heavy traffic. For example, when the number of times that a speed threshold is crossed exceeds a threshold number, a heavy traffic condition is identified. In another example, when the distance traveled in a particular time interval exceeds a threshold, a heavy traffic condition is not identified.

If the processor determines that the mobile device 102 is not in heavy traffic at decision block 716, then the control criteria are set to (or maintained at) their “normal traffic” values at Step 718, and the processor proceeds to decision block 722 (discussed below). However, if the processor determines that the mobile device 102 is in heavy traffic, the processor assesses whether the current control criteria are set to their heavy traffic values at decision block 720. If not, the control criteria are altered to their heavy traffic values at Step 721. In preferred implementations, altering the control criteria at Step 721 includes increasing the safe speed threshold against which the speed of the mobile device 102 is compared to determine whether the permitted uses should be changed. Increasing the safe speed threshold advantageously allows the control criteria to adapt to periodic small accelerations without triggering the transmission of an ACM or the potential disruption caused by frequent changes of the permitted uses of the mobile device 102. For example, to accommodate for periodic quick bursts of acceleration, the safe speed threshold may be altered from 10 miles per hour to 20 miles per hour. The processor may make use of web- or feed-based traffic control information about the location at which the mobile device 102 is traveling, to adjust the safe speed threshold to an appropriate heavy traffic level of 20 miles per hour.

In some implementations, altering the control criteria at Step 721 comprises extending a time interval over which the speed must exceed a speed threshold in order for the use of the mobile device 102 to be selectively permitted. For example, in normal traffic, the processor may be configured to transmit an ACM when it determines that the speed of the mobile device 102 exceeds ten miles per hour for five seconds. In heavy, stop-and-go traffic, the control criteria may be altered so that the mobile device 102 must exceed ten miles per hour (or a higher threshold speed) for ten seconds before the control criteria are met and use of the mobile device 102 is selectively permitted.

In some implementations, altering the control criteria at Step 721 comprises applying additional signal processing steps to a motion signal (such as a location, speed, acceleration or bearing signal), then applying one or more criteria to the processed motion signal. For example, when heavy traffic is detected, the control criteria may be altered to require that a filtered version of a motion signal exceeds or falls below a threshold. In some such implementations, once a heavy traffic condition has been identified, the motion signal is low-pass filtered (e.g., by a moving average) and the low-pass filtered signal compared to a second speed threshold that is lower than the safe speed threshold. When the low-pass filtered signal exceeds the second speed threshold, the use of the mobile device 102 is selectively permitted. In such an implementation, the speed threshold at which mobile device use restriction occurs is lowered due to the presence of heavy traffic. Additional or different signal processing techniques may also extract other frequency information from the motion signal that can be used to alter the control criteria to adapt appropriately to heavy traffic situations.

Once the control criteria are altered at Step 721, the processor returns to execute

Step 708 by taking another GPS reading. As long as the heavy traffic condition is maintained, the altered control criteria will be used to determine how and when the permitted uses of the mobile device 102 will change. Once the traffic condition clears (e.g., as indicated by the traffic control information or some of the speed variation measures described above), the processor will revert the control criteria to their nominal settings (i.e., the safe speed threshold will be decreased to its previous value of 10 miles per hour). Failure to receive an ACM for a predetermined period of time may also indicate a maintained high speed or low traffic condition, and thus cause the control criteria to revert to their nominal “normal traffic” values.

In some implementations, information about the motion patterns of the mobile device 102 are stored in a database (e.g., the access database 222) and are used to “learn” habitual traveled conditions of the mobile device 102. Using known pattern recognition techniques, such implementations account for rush hour traffic experienced on a repeated basis, such as a commute to work or to school. For example, if the user of the mobile device 102 travels in New York City on 5th Avenue, Monday through Friday at 7:00 A.M., the processor stores identified heavy traffic conditions as discussed above in the database and utilizes that information to alter the control criteria to include a heavy traffic safe speed threshold in the MAP 123 during that time period. In this way, one of the criteria now stored as part of the MAP 123 would include an automatic alteration of the control criteria to the heavy traffic settings at a predetermined time period during predetermined days of the week, when the processor identifies that the mobile device 102 is within a radius of a predetermined location.

Many useful techniques for controlling mobile device operation were described above and illustrated with reference to FIGS. 1-7. Some of these techniques involve the use of a positioning system, such as GPS, to estimate the position of the mobile device. This position estimate can be used for a number of different control techniques, such as calculating the speed at which the mobile device is traveling. However, as noted above, continuously invoking a positioning system can quickly deplete the energy, processing, storage and bandwidth resources of the mobile device. Existing technologies fail to adequately address the challenges of mitigating GPS power consumption in mobile device control applications. Described below, and illustrated with reference to FIGS. 8-15, are systems and techniques that address this problem by selectively invoking a positioning system for use in mobile device control applications. In particular, these techniques include using a number of different non-position-based sensing modalities (e.g., acceleration, bearing and wireless network signals), both independently and in combination, to reduce the frequency with which an energy-expensive positioning system is invoked.

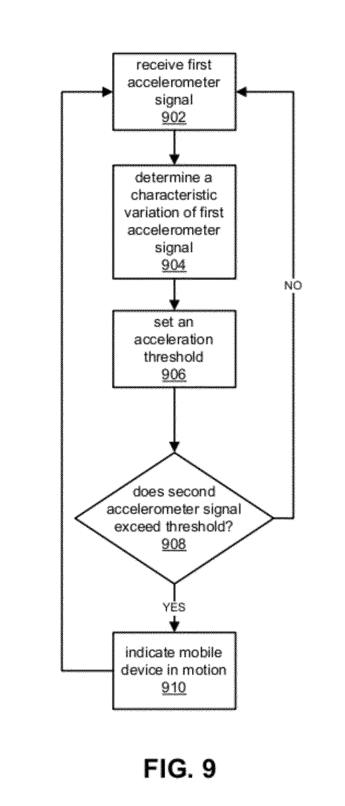

FIG. 8 is a flow chart of a method of selectively invoking a positioning system using multiple non-position-based sensors. Such methods and systems are also discussed in co-pending U.S. patent application Ser. No. 12/950,605, filed Nov. 19, 2010, incorporated in its entirety by reference herein. The method of FIG. 8 is described with reference to first and second non-position-based sensors, but the method is naturally and usefully applied to embodiments in which only one non-position-based sensor is present, or three or more non-position-based sensors are present. Examples of specific non-position-based sensors, and associated mobile device motion techniques, are discussed below with reference to FIGS. 9-15.

At Step 802, the processor receives a first signal from a first non-position-based sensor. Such a signal may be, for example, an accelerometer signal, an electromagnetic compass signal, a wireless network environment signal, an anemometer signal, or a vibration detector signal. At Step 804, the processor receives a second signal from a second non-position-based sensor (which may take the form of any of the non-position-based sensors described herein). In some embodiments, the first and second non-position-based sensors are the same types of sensor.

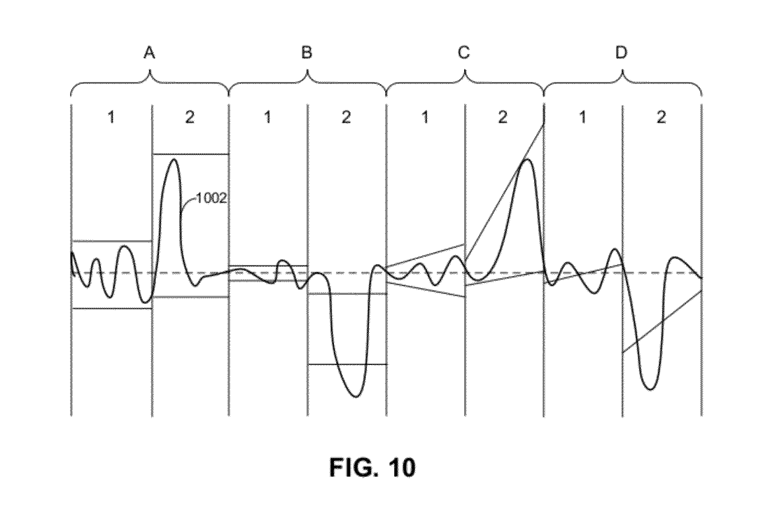

At decision block 808, the processor determines whether the first and second signals are indicative of motion of the device. The processor may make this determination by evaluating one or both of the first and second signals (or more in embodiments in which there are more than two signals). Some exemplary techniques that the processor may execute at decision block 808 include:
Determining whether at least one of the received signals indicates that the mobile device 102 is in motion.
Determining whether at least a threshold number of the received signals indicates that the mobile device 102 is in motion. For example, if an accelerometer signal indicates that the mobile device 102 is in motion (e.g., using the technique illustrated in FIG. 9), then the processor may also determine whether a signal from an electromagnetic compass indicates that the mobile device 102 is in motion (e.g., using the technique illustrated in FIG. 10). Once the processor determines that the signals received from both of these sensing modalities indicates mobile device motion, the processor may determine that the mobile device 102 is in motion.
Determining whether a majority of the received signals indicates that the mobile device 102 is in motion. This technique is usefully applied in embodiments that include three or more non-position-based sensors.

If the processor determines at decision block 806 that the mobile device 102 is not in motion, the processor returns to Step 802 to receive additional signals from the non-position-based sensors. If the processor determines at decision block 806 that the mobile device 102 is in motion, the processor proceeds to execute Step 808 and invokes a positioning system to receive a measurement of the position of the mobile device 102. In preferred embodiments, the positioning system is a GPS, but other positioning systems, such as GSM and cell tower localization, may be used.

The processor then proceeds to decision block 810 to determine whether a user of the mobile device 102 is likely in control of a vehicle. In some embodiments, the processor receives a signal from the vehicle controller 306 (FIG. 3) that indicates that a vehicle associated with the mobile device 102 is in operation, indicating that a user of the mobile device 102 is in control of the vehicle. In some embodiments, the processor uses the position measurement obtained at Step 808 to make the determination of decision block 810. For example, in some embodiments, the processor determines at decision block 810 whether the mobile device is moving at a speed faster than a threshold speed. In preferred embodiments, the processor makes this speed threshold determination without calculating the speed of the mobile device. For example, the processor may make a first position measurement, calculate a future position sampling interval based on the threshold speed, then take a second position measurement after the future position sampling interval has elapsed. If the distance travelled between the first and second position measurements exceeds a threshold distance, the processor determines that the mobile device is traveling faster than the threshold speed. Additional details of such speed threshold determination techniques are provided by Fernandez et al. in U.S. patent application Ser. No. 12/890,354, “Systems and Methods for Determining Sampling Intervals For Position Readings,” filed Sep. 24, 2010 and incorporated by reference herein in its entirety.

After the processor determines whether the user mobile device 102 is traveling in a vehicle at decision block 810, the processor proceeds to dynamically adapt a prioritization scheme associated with the non-position-based sensors. In particular, if the processor determines that the mobile device 102 is not traveling in a vehicle (based on the position measurement of Step 808) at decision block 810, the processor proceeds to Step 812 to decrease the priority of one or more of the sensors that indicated that the mobile device 102 was in motion at decision block 806. Alternately, if the processor determines that the mobile device 102 is traveling in a vehicle (based on the position measurement of Step 808) at decision block 810, the processor proceeds to Step 812 to increase the priority of one or more of the sensors that indicated that the mobile device 102 was in motion at decision block 806. These priorities are part of a prioritization scheme maintained by the processor, which includes a priority for each of the non-position-based sensors that provide motion-indicative measurements. The processor can use this prioritization scheme in the method of FIG. 8 in any of a number of ways. In some implementations, the processor uses the prioritization scheme to determine a sampling frequency for each of the non-position-based sensors. Higher priority sensors are sampled more frequently then lower priority sensors. In some implementations, the processor uses the prioritization scheme to determine an order in which the different non-position-based sensors are queried when the processor is attempting to determine whether the mobile device 102 is in motion (e.g., Steps 802-804 and decision block 806). Higher priority sensors are queried before lower priority sensors. In some implementations, when a lower priority sensor signal indicates that the mobile device 102 is in motion, the processor will query a higher priority sensor to confirm that its signal also indicates that the mobile device 102 is in motion (e.g., before proceeding to invoke the positioning system at Step 808). In this manner, the processor can selectively utilize the signals from different sensors based on their priority, which can be dynamically adjusted according to the particular sensor's success at predicting when the mobile device 102 is traveling in a vehicle. This approach is especially advantageous in environments in which the motion and the environment of the mobile device 102 are changing; the processor can adapt to the changing conditions by adjusting its reliance on the sensing modalities that provide the best motion detection performance for the current conditions.

Proceeding to Step 816, once the processor has determined that the mobile device 102 is traveling in a vehicle (decision block 810) and adjusted sensor priorities accordingly (Step 814), the processor evaluates control criteria and applies the resulting controls to the mobile device 102. The operations performed by the processor at Step 816 can include any of the mobile device control techniques described herein (e.g., disabling/enabling one or more features of the mobile device 102 when the mobile device 102 is traveling faster than a predetermined speed threshold). For example, if the speed of the mobile device 102 exceeds a safe speed threshold, one or more features of the mobile device 102 may be disabled.

FIGS. 9-15 describe and illustrate a number of different techniques for determining whether a non-position-based sensor signal indicates that the mobile device 102 is in motion

(Step 806 of FIG. 8). FIG. 9 depicts a method for detecting relevant motion of a mobile device based on processing accelerometer signals. The method includes identifying a characteristic variation of accelerometer signals when the mobile device is not traveling in a vehicle, and using that characteristic variation to identify an acceleration threshold. When an accelerometer signal exceeds the acceleration threshold, the mobile device is likely to be undergoing a rapid change in speed (e.g., beginning travel in a vehicle), and in response, a positioning system is triggered to supply a position measurement (e.g., a GPS measurement). In these techniques, an accelerometer included with or coupled to the mobile device 102 provides a first acceleration signal representative of the motion of the mobile device 102 (Step 902). This first acceleration signal is monitored over time to determine a characteristic variation of the signal (Step 904). The characteristic variation may approximate the “expected” or “normal” fluctuations in acceleration when the mobile device 102 is not traveling in a vehicle (e.g., the mobile device is stationary or being carried by a pedestrian). The characteristic variation is used to set an acceleration threshold (Step 906). When a second accelerometer signal exceeds the acceleration threshold (decision block 908), motion of the mobile device 102 is indicated (Step 910).

In the description of FIG. 9 below, continued reference will be made to the accelerometer signal waveform of FIG. 10, which will be used to illustrate several different techniques for determining a characteristic variation of an accelerometer signal. The mobile device control techniques illustrated by FIG. 9 improve upon existing technologies in many ways; in particular, by intelligently and adaptively determining when a power-hungry positioning system should be invoked to monitor the motion of a mobile device. Several implementations of this technique are described below.

At Step 902, the processor begins by receiving a first accelerometer signal representative of motion of the mobile device 102. As described above, an accelerometer may be embedded within controller 104, or may be in electronic or wireless communication with controller 104. The accelerometer may be embedded within the mobile device 102 itself, or may be mechanically attached to mobile device 102 (e.g., by an adhesive or screw-mount). The accelerometer may have one, two, three or more axes, and may be capable of generating scalar-valued signals or vector-valued signals representative of magnitude and/or direction of linear acceleration and/or rotation. The accelerometer may include piezoelectric, piezoresistive, Hall effect, magnetoresistive, capacitance, resonance, optical or any other suitable components used in any known accelerometer. The accelerometer may be digital or analog, or capable of generating digital and analog signals. The accelerometer may be part of a package that includes signal processing circuitry configured to identify particular kinds of motion, including falling, impact, step-counting, and orientation. An accelerometer package may also include a power supply, a memory device for storing accelerometer signals (e.g., an EEPROM or Flash memory), and an interface for outputting the accelerometer signals to another circuit or device (e.g., a USB or serial interface). Many examples of suitable accelerometers are manufactured by Analog Devices of Norwood, Mass.

In some implementations, the processor receives the first accelerometer signal at Step 902 as a plurality of discrete samples at periodic time intervals. These intervals may correspond to the sampling rate of the accelerometer, or the processor may down-sample signals generated by the accelerometer (e.g., by only receiving every ten or fifty accelerometer signal samples). In some implementations, discrete samples of the first accelerometer signal are not received at regular time intervals, and instead are received at varying time intervals (e.g., only when the accelerometer signal exceed a noise floor, or when another motion-sensing modality, such as a compass, triggers the accelerometer). In some implementations, the processor may interpolate the discrete samples of the first accelerometer signal and treat the first accelerometer signal as a continuous waveform. For example, a continuous accelerometer signal waveform 1002 is illustrated in FIG. 10. The continuity of accelerometer signal 1002 is for ease of illustration, and all techniques described herein are suitably performed with a plurality of discrete accelerometer signals.

In some instances, a portion of the first accelerometer signal received at Step 902 is received when mobile device 102 is traveling in a vehicle, or is not traveling in a vehicle. The processor may distinguish between these conditions in any of a number of ways. In preferred implementations, the processor automatically distinguishes intervals of vehicular travel from intervals of non-vehicular travel by analyzing the variation in the accelerometer signal during these intervals. Such implementations are described in additional detail below with respect to Step 904. In some implementations, a user may use input interface 112 (FIG. 1) to indicate to the processor when the mobile device 102 is or is not traveling in a vehicle (e.g., by pushing a designated button), and the processor may use this indication to help determine an acceleration threshold as described in additional detail below. In some implementations, the processor determines whether the mobile device 102 is traveling in a vehicle by querying one or more environmental or vehicle-based sensors (e.g., an ambient electromagnetic signal detector tuned to identify a vehicle alternator frequency, or a driver seat pressure sensor). In some implementations, the processor determines that the mobile device 102 had been traveling in a vehicle after receiving the first accelerometer signal. The processor may make this determination by comparing position measurements taken before and after the receipt of the portion of accelerometer signals and determining that the mobile device 102 must have traveled in a vehicle due to the necessary speed of travel (or by identifying a portion of the first accelerometer signal with a low variation, as discussed below).

At Step 904, the processor determines a characteristic variation in the first accelerometer signal. This characteristic variation is used by the processor to identify a “background” or “expected” amount of variation in acceleration that characterizes time periods in which the user's speed is not changing enough to warrant invoking the positioning system or implementing the mobile device controls described elsewhere herein. Examples of such time periods include when a user is walking, jogging, playing a sport, working around the house or office, or riding in a steady train. The characteristic variation determined at Step 904 may be a variation in only a portion or portions of the first accelerometer signal. For example, in some embodiments, a user may indicate start and end times for a period of walking, and the characteristic variation is a variation of the accelerometer signals received between the start and end times. In some embodiments, the first accelerometer signal may be automatically divided into two or more contiguous or non-contiguous portions (e.g., several two-second intervals), and the processor may calculate a variation associated with some of or all of the portions and designate that variation to be the characteristic variation. For example, the accelerometer signal 1002 of FIG. 10 is shown as divided into eight contiguous portions (demarcated by the vertical lines, and labeled A1, A2, B1, B2, C1, C2, D1 and D2). At Step 904, the processor may calculate a variation associated with each portion, and select one or more of these variations to be the characteristic variation.

The processor may determine a characteristic variation at Step 904 in any of a number of ways, including the following:
Determining a range of variation. In some embodiments, a range of the first accelerometer signal is defined as the approximate difference between the magnitude of its most positive value and the magnitude of its most negative value. The ranges of portions A1 and A2 of the accelerometer signal 1002 of FIG. 10 are indicated by the horizontal lines in those portions. In some embodiments, the range may be defined as the difference between the maximum absolute magnitude and the minimum absolute magnitude of the first accelerometer signal. Such embodiments are particularly useful when the accelerometer is only capable of measuring absolute magnitudes of acceleration (and not, for example, direction).
Determining a deviation from a central value. In some embodiments, the processor may identify a central value of portion of the first accelerometer signal. Suitable central values include, but are not limited to, a mean value (e.g., geometric or arithmetic mean value), a median value, a mode value, and a minimum error estimator value. Once a central value is identified, the processor may determine a variation at Step 904 by determining a deviation of the first accelerometer signal from the central value. A deviation may be a standard deviation, an absolute deviation, or a higher-order moment. A deviation may be a symmetric range around the central value that includes a specified percentage of the first accelerometer signal (e.g., 80%). In some embodiments, the deviation may be an interquartile value. For example, one standard deviation from the mean value of the portions B1 and B2 are indicated by the horizontal lines in those portions of FIG. 10.
Determining an area between bounding curves. In some embodiments, the processor determines a variation in the first accelerometer signal at Step 904 by identifying at least two curves (e.g., lines or parabolas) that bound or otherwise represent an envelope of the first accelerometer signal. For example, portions C1 and C2 of FIG. 10 each include two lines of non-zero slope that approximate an envelope of the accelerometer signal 1002 over the respective portions. Although the bounding curves in portions C1 and C2 of FIG. 10 are lines, any higher-order or non-linear curves may be used. At Step 904, the processor may determine the area between the two bounding curves and use that area as the characteristic variation of the first accelerometer signal.
Determining the slope or higher-order derivative of an approximating curve. In some embodiments, the processor determines a line or other curve that approximates the first accelerometer signal. The slope of the line (or a higher-order derivative) may indicate the variability of the first accelerometer signal. For example, portions D1 and D2 of FIG. 10 each include a linear approximation of the accelerometer signal 1002 over the respective portions. The processor may determine the characteristic variation of the first accelerometer signal by determining the slope of each of such approximating curves. Linear or non-linear approximations may be minimum mean-square error estimators, minimum absolute error estimators, or any other regression curves.

In some embodiments, one or more of the foregoing variation determination techniques, or any other variation determination technique, may be combined in Step 904 when determining the characteristic variation. The processor may calculate, for example, a weighted average of two or more variations to determine a characteristic variation to use in the remainder of the technique 900 of FIG. 9.

As illustrated in several of the examples discussed above, in some embodiments of Step 904, the processor calculates the characteristic variation of the first accelerometer signal by determining a variation in two or more portions of the first accelerometer signal. In some instances, one or more of the portions may represent accelerometer signals received when the mobile device 102 was traveling in a vehicle. In this case, a characteristic variation that is determined based on those portions may be indicative of the amount of variation that is expected when the mobile device 102 is traveling in a vehicle. More specifically, the variations determined during these portions may be indicative of different stages of vehicular travel; for example, onset, cruising, and stopping. In FIG. 10, portion A2 may be indicative of vehicular travel onset, portion B1 may be indicative of vehicular travel cruising, and portion B2 may be indicative of stopping vehicular travel. Portions A2 and B2 exhibit relatively large variations, while portion B1 exhibits a relatively small variation. Portions A1 and C1 may be indicative of acceleration signals received when the mobile device 102 is not traveling in a vehicle (e.g., when the device 102 is being carried by a user on foot). In portions A1 and C1, the variation of the accelerometer signal 1002 is relatively small compared to the variation of portions A2 and B2, and may be on the same order of magnitude of the variation of portion B1 (or not).

In some embodiments of Step 904, the processor analyzes one or more portions of the first accelerometer signal, determines a variation of each of the portions, and identifies some of the portions that have larger variations and some of the one or more portions that have smaller variations. The portions with smaller variations are used to determine the characteristic variation. Any known clustering or classification technique may be used to identify the portions accordingly. For example, the processor may identify a fixed number of portions that have the smallest variations and classify those portions as smaller variation portions. In another example, the processor may identify a fixed number of portions that have the largest variations and classify those portions as larger variation portions; the remaining portions are classified as smaller variation portions. The foregoing are simply examples of the characteristic variation determination techniques that may be executed by the processor at Step 904, and many additional techniques are also suitable.

At Step 906, the processor sets an acceleration threshold based at least in part on the characteristic variation determined at Step 904. The processor may set the acceleration threshold by storing a value for the threshold in a memory for later retrieval. In some embodiments, the processor sets the acceleration threshold to be greater than or equal to the characteristic variation. For example, if the processor determines that a portion of the first accelerometer signal has a relatively small variation, the processor may set an acceleration threshold that is greater than or equal to a characteristic variation of that portion. In some embodiments, the processor sets the acceleration threshold to be less than or equal to a maximum of the absolute value of a portion of the first accelerometer signal (e.g., a small variation portion). In some embodiments, the processor sets the acceleration threshold to satisfy both of these conditions: greater than or equal to the characteristic variation, and less than or equal to a maximum absolute value of a portion of the first accelerometer signal.

In some embodiments, the processor sets the acceleration threshold by looking at multiple portions of the first accelerometer signal. For example, the processor may determine characteristic variations associated with accelerometer signals obtained at similar times of day for multiple days in order to learn a “typical” variation associated with the motion of the mobile device 102 at the particular time of day. In another example, the processor may identify one or more portions of the first accelerometer signal during which a user signaled to the controller 104 that the user was walking or was stationary with the mobile device 102. The processor may use the characteristic variations of these portions at Step 906 to set the acceleration threshold equal or greater to an average or maximum characteristic variation of these portions.

At decision block 908, the processor determines whether a second accelerometer signal exceeds the acceleration threshold set at Step 906. The second accelerometer signal may be a portion of the first accelerometer signal received at Step 902, or may be a newly received accelerometer signal. The second accelerometer signal may include one or more discrete accelerometer signal samples. The processor may determine that the second accelerometer signal exceeds the acceleration threshold at decision block 908 if the absolute value of the accelerometer signal exceeds an absolute value of the acceleration threshold.

If the processor determines at decision block 908 that the second accelerometer signal does not exceed the acceleration threshold, the processor returns to Step 902 to receive additional accelerometer signals. If the processor determines at decision block 908 that the second accelerometer signal exceeds the acceleration threshold, the processor proceeds to Step 910 and indicates that the mobile device 102 is in motion.

In some applications, an acceleration threshold can be supplied by an external source (e.g., a remote processor) or pre-programmed into the mobile device 102. The acceleration threshold can be predetermined by a manufacturer or software/hardware provider based on testing conducted with the particular model of the mobile device 102 and the accelerometer, when undergoing vehicular and non-vehicular travel. During this testing, an accelerometer signal can be analyzed in advance, and an appropriate acceleration threshold determined. In operation, the processor receives this acceleration threshold (e.g., from a memory), and proceeds with the technique of FIG. 9 starting with decision block 908 by comparing an accelerometer signal to the acceleration threshold.

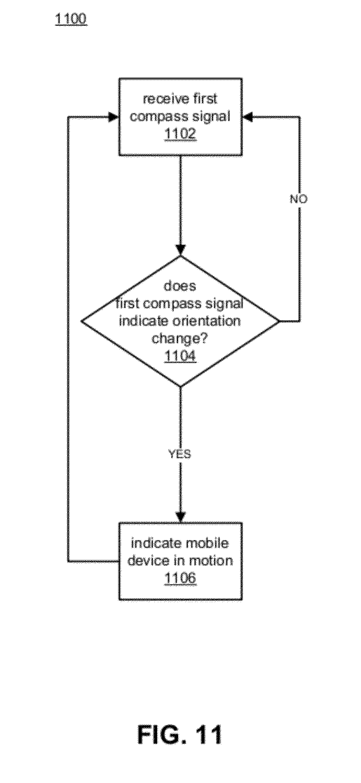

FIG. 11 illustrates an electromagnetic compass-based technique for determining when the mobile device 102 is in motion. At Step 1102, the processor receives a first signal from an electromagnetic compass coupled with the mobile device 102. The compass can be configured to passively detect the vector of the Earth's magnetic field relative to the device and output this data as an electronic signal. At Step 1104, the processor analyzes the first signal to determine whether a change in the orientation of the mobile device 102 has occurred. Changes in the orientation of the mobile device 102 are reflected as a change in the vector detected by the compass, resulting in a change in the output signal. Using compass signal data can be challenging because the Earth's magnetic field is weak and many noise sources, such as electrical devices, produce electromagnetic signals that interfere with the compass reading. Consequently, compass data often has a low signal-to-noise ratio. However, a processor configured to execute statistical analysis techniques can detect real changes in mobile device orientation despite the high noise level. Some statistical analysis techniques that may be used include maximum a posteriori (MAP) detection, constant false alarm rate (CFAR) detection, likelihood ratio testing, and techniques based on specific receiver operating characteristics that model the operating conditions of the compass. When the processor does not detect a significant change in the magnetic vector of the compass at decision block 1106, the mobile device 102 is likely stationary and the processor returns to Step 1102 without indicating that the mobile device 102 is in motion. However, if the processor detects a change in the magnetic vector at decision block 1106, the processor indicates that the mobile device 102 is in motion at Step 1108.

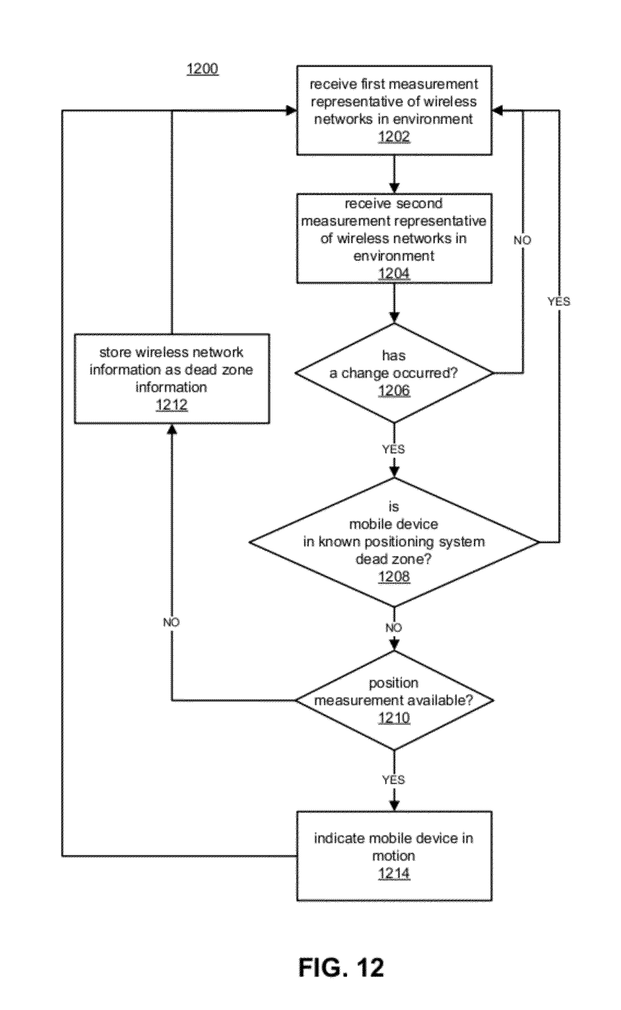

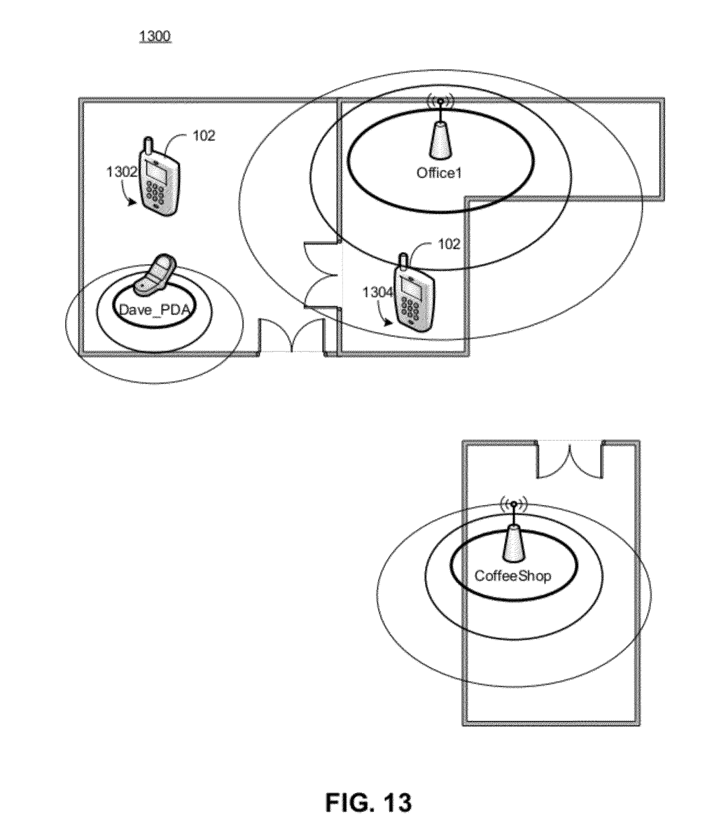

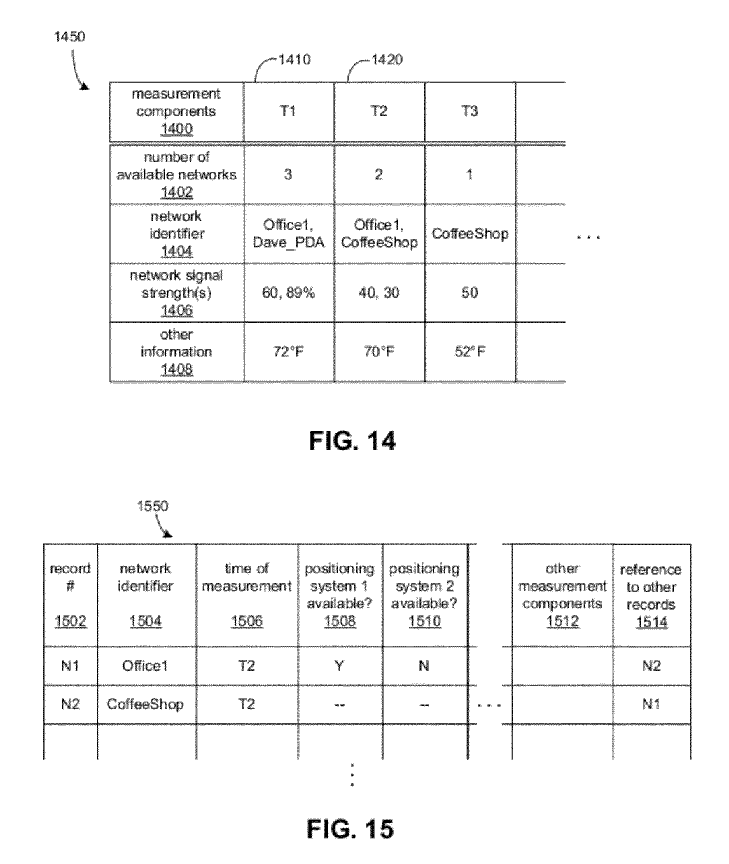

FIG. 12 illustrates another non-position-based sensor technique for determining when the mobile device 102 is in motion. In particular, FIG. 12 is a flow chart of a method of indicating motion of a mobile device using measurements of wireless networks in an environment of the mobile device. Such methods and systems are also discussed in co-pending U.S. patent application Ser. No. 12/950,549, filed Nov. 19, 2010, incorporated in its entirety by reference herein. At Step 1202, a processor receives a first measurement at a first time representative of one or more wireless networks in an environment of mobile device 102. In some implementations, the one or more wireless networks includes a wireless communications network, such as a wireless local area network (WLAN), a wireless wide area network (WWAN), or a wireless metropolitan area network (WMAN). For example, the first measurement may be representative of a WLAN operating under the IEEE 802.11 standard, including IEEE 802.11b (“WiFi”) networks, which may be configured in infrastructure mode using a wireless access point or an ad hoc mode in which client devices connect directly to each other starting from an initial wireless client. In some embodiments, at Step 1202 the processor receives a first measurement representative of a personal area network in the environment of mobile device 102. For example, the first measurement may be representative of a Bluetooth-enabled device within a range of approximately 10-20 m of the mobile device 102, an IEEE 802.15-enabled device, or a WiFi Direct-enabled device. FIG. 13 depicts an illustrative mobile device motion scenario in which the technique of FIG. 12 is usefully applied. In FIG. 13, the mobile device 102 is in a first position 1302 at the time of the first measurement (Step 1202 of FIG. 12). At this time, the mobile device 102 receives a measurement representative of the presence of two wireless networks: a network associated with the access point Office1, and a network associated with a mobile WiFi device Dave_PDA. FIG. 14 is a schematic representation of the measurement data 1450 representative of wireless networks in the mobile device motion scenario of FIG. 13. In particular, the measurement data received at Step 1202 of FIG. 12) is represented in data column 1410. The components of the measurement in data column 1410 are discussed in detail below.

The first measurement received at Step 1202 includes one or more measurement components. Each measurement component may be a distinct raw data signal received by the processor, or may be the result of intermediate processing (such as decoding, decryption, filtering, or counting). In some implementations, the processor may process the measurement signal received at Step 1202 to identify the total number of wireless networks in the environment of the mobile device 102 at the time of the measurement (see, e.g., row 1402 of FIG. 14). In some implementations, the processor may process the measurement signal received at Step 1202 to determine an identifier for each of the wireless networks in the environment of the mobile device at the time of the measurement (see, e.g., row 1404 of FIG. 14). For example, Bluetooth data packets include channel access codes that identify a particular piconet, and the unique address of particular Bluetooth devices. In WLANs, access points or initial clients broadcast service set identifiers (SSIDs), also known as wireless network names. Additionally, wireless clients send out probe requests, and access points send responses to those probe requests; identifier information may be obtained from any of these transmissions. In preferred embodiments, wireless networks are identified by the MAC addresses of the network hardware instead of using the network's SSID. These embodiments are particularly advantageous when an SSID is shared across a large geographical region, such as “Boston Free WiFi.” Since each of the hardware access points in the network has a different MAC address, using the MAC address as the network identifier may improve the resolution with which changes in position can be detected.

In some implementations of Step 1202, the first measurement includes a signal strength for each of the wireless networks in the environment of the mobile device at the time of the measurement (see, e.g., row 1406 of FIG. 14). Signals strengths can be affected by distance from the signal source and the presence of interfering objects or other signals. Different device manufacturers and different wireless protocols measure signal strength in different ways; for example, as decibel milliwatts (dBm). In some implementations, the processor determines a Received Signal Strength Indicator (RSSI) for each of the wireless network signals received at Step 1202.

In some implementations of Step 1202, the measurement received by the processor includes two or more measurement components (e.g., any of the components described above). As discussed in additional detail below, the processor may treat a multi-component measurement as a vector when conducting downstream processing operations.

Additional information can also be included in a multi-component measurement at Step 1202, including WHOIS query information for a particular detected IP address, validated location data for a particular detected IP address, environmental data (e.g., temperature, wind speed), time and date stamps, information from other motion sensors (e.g., accelerometers, acoustic sensors, imaging sensors), and user-provided information (e.g., an indication from a keypad that a particular location is underground). FIG. 14 indicates memory space allocated for this additional information in row 1408.

After receiving a first measurement at Step 1202, the processor proceeds to Step 1204 and receives a second measurement representative of one or more wireless networks in an environment of the mobile device 102. The second measurement may include any of the components described above with reference to the first measurement, and may include the same components as the first measurement or different components. Returning to the illustrative scenario of FIG. 13, the mobile device 102 is in position 1304 when the second measurement is received by the processor (Step 1204 of FIG. 12). The data from this second measurement is illustrated in FIG. 14 in data column 1420. In this scenario, the mobile device 102 is no longer within communication range of the mobile WiFi device Dave_PDA (FIG. 13), but is still within range of the WLAN Office1. Additionally, in position 1304, the mobile device 102 can detect another wireless network, CoffeeShop.

The processor may receive the first and second measurements at first and second times, respectively, spaced apart by a predetermined interval. The predetermined interval may correspond to a predetermined sampling frequency (e.g., once per minute). In some implementations, the first and second measurements are each triggered by a triggering event, such as a detection of a sudden acceleration or a change in temperature. In some implementations, the first and second measurements are not consecutive measurements, but are separated by intervening measurements that are disregarded by the processor.

When receiving measurements at Step 1202 or Step 1204, the processor may disregard certain types of measurement data. In some embodiments, the processor may identify certain access points or network hardware as mobile WiFi points (e.g., mobile “hotspots”) and disregard this wireless network information for the purposes of determining whether there is a substantial difference between the wireless networks in the environment of the mobile device 102 (e.g., Step 1206, discussed in detail below). For example, the processor may identify hardware as a mobile WiFi device by analyzing its MAC address and determining, for example, that the first three bytes of the MAC address (the Organizationally Unique Identifier, or OUI) correspond to a manufacturer of mobile WiFi devices. The MAC address may then be added to a blacklist and disregarded in future iterations of the technique of FIG. 12. Alternatively, or in addition, the processor deems a detected wireless device to be a mobile device if the processor previously detected the device's MAC address at a substantially different position than its current position. The processor then associates devices deemed to be mobile to a blacklist and disregards them in the future. This approach is illustrated by FIGS. 13 and 14, in which the mobile device 102 detects mobile Wifi device Dave_PDA in the first measurement at position 1302 of FIG. 13 (Step 1202 of FIG. 12, data column 1410 of FIG. 14). In later processing, the mobile WiFi device Dave_PDA will be ignored (i.e., by referring to a blacklist in which the mobile WiFi identifier has been stored), and in some embodiments, is not subsequently recorded in memory.

At decision block 1206, the processor compares the first and second measurements to determine that the first and second measurements are substantially different and thus a substantial change in the wireless networks in an environment of the mobile device has occurred. The processor may perform the comparison at decision block 1206 in any of a number of ways, including the following:
Treating each measurement as a vector and applying a vector comparison, such as an inner product, a cross product, a Euclidean distance, a correlation coefficient or an angular distance. For measurement components that are non-numerical, such as an identifier that includes a string of alphabetical characters, the processor may perform a preliminary step to quantify the non-numerical component (e.g., replacing an alphabetical string with the number of characters in the string), or the processor may perform an alternative comparison step (e.g., returning a very large dissimilarity value when two non-numerical strings are different, and a very small or zero dissimilarity value when the strings are identical).
Applying a sequence comparison technique, such as global or local alignment techniques used in bioinformatics, dynamic programming, and word methods.
Applying an edit distance metric, such as Hamming distance, Levenshtein distance,

Damerau-Levenshtein distance, Jaro-Winkler distance, and Wagner-Fischer distance.

A combination of any of the above comparison techniques may also be used. In some implementations, different comparison techniques may be used for different components of the measurements. The number and type of comparison techniques used can also be dynamically adapted to changing conditions. For example, when the quality of signal strength measurements is low, a new comparison technique that places less or no emphasis on the signal strength measurements may be used. In some implementations, the processor compares more than two measurements at decision block 1206. In such implementations, the processor may use any of the above comparison techniques, multiple sequence alignment techniques (e.g., progressive or iterative optimization methods), or clustering techniques.

The processor compares the first and second measurements at decision block 1206 to determine whether a change has occurred in the wireless networks in the environment of the mobile device 102. After performing the comparison (e.g., as described above), the processor determines whether the result of the comparison indicates that the first and second measurements are sufficiently similar to conclude that the mobile device 102 is in the same environment, or sufficiently different to conclude that the mobile device 102 has moved to a different environment. In some implementations, the processor evaluates the comparison between the first and second measurements against a threshold. For example, when the first and second measurements are treated as vectors, and the comparison includes calculating their correlation coefficient, the processor may conclude that the wireless networks are not substantially different if the value of the correlation coefficient is greater than 0.5; otherwise, a substantial change has occurred. In another example, when none of the wireless network identifiers of the first measurement are present in the wireless network identifiers of the second measurement, the processor may conclude that a change has occurred; otherwise, no change has occurred. In another example, when any of the wireless network identifiers have changed between the first and second measurements, the processor may conclude that the two measurements are substantially different; otherwise, no change has occurred.

Applying Step 1206 of FIG. 12 to the measurement data 1450 of FIG. 14, the processor compares data columns 1410 to 1420 to determine whether a substantial difference is present, indicating that a substantial change in the wireless network environments of the mobile device 102 has occurred. For example, if the processor is configured to determine that a change has occurred whenever the networks identifiers of the second measurement are different from the network identifiers of the first measurement, the processor will determine that a change has in fact occurred between the first and second measurements based on the measurement data in FIG. 14.

If the processor determines at decision block 1206 that the first and second measurements are substantially different, and thus a substantial change in the wireless network environment has occurred, the processor proceeds to decision block 1208 to determine whether the mobile device is in a positioning system “dead zone,” (i.e., an environment in which position measurements from the positioning system are unavailable or of low quality). In some embodiments, the processor evaluates decision block 1208 by comparing at least one of the first and second measurements to stored dead zone information that represents known environments in which position measurements are not available. The processor may make this determination by comparing a network measurement to a stored history of network measurements which were received at substantially the same time that position measurements were attempted. FIG. 15 is a schematic representation of stored measurement data and positioning system availability data in accordance with an embodiment. When the processor makes a wireless network measurement close to the same time as an attempted position measurement, the processor can store the result in the table 1550 of FIG. 15, which records a record number 1502, a network identifier 1504 of the measurement, a time of the measurement 1506, whether a first positioning system was available at that measurement (1508), whether a second positioning system was available at that measurement (1510, optional), other measurement components 1512, and any cross-references to other records (1514) (e.g., other records that arose from the same measurement). In some embodiments, data from wireless network measurements is stored in a hash table.

If the stored history (e.g., table 1550 of FIG. 15) indicates that no position measurement was available when a similar wireless network measurement was received in the past, the processor determines that the mobile device 102 is likely in a positioning system dead zone, and does not proceed to indicate that the mobile device is in motion. Instead, the processor returns to Step 1202 to receive additional wireless network measurements. In some embodiments, the processor waits for a delay period between deciding “YES” at decision block 1208 and executing

Step 1202. As a result of performing the assessment at decision block 1208, the processor will not expend the mobile device's resources in an attempt to make a position measurement that is not likely to succeed (e.g., because the mobile device is located indoors and cannot send or receive GPS transmissions). The processor can assess similarity at decision block 1208 in any of the ways described above for the comparison of measurements at decision block 806. In some embodiments, the processor executes decision block 1208 before decision block 806; if the processor determines that a position measurement is not likely to succeed (decision block 1208), the processor will return to execute Step 1202 and not proceed to decision block 806. In some embodiments, the processor only executes one of decision blocks 806 and 808.

If the processor does not determine from the history of previous measurements that the mobile device 102 is in a positioning system dead zone, and thus that an attempt to invoke a positioning system may succeed (decision block 1208), the processor proceeds to decision block 1210. At decision block 1210, the processor determines whether or not a measurement of the position of the mobile device 102 is available from the positioning system (i.e., the mobile device 102 is in a positioning system dead zone). In some implementations, the processor may wait until the positioning system has been invoked (e.g., at Step 808 of FIG. 8) and determine that no position measurement is available when an insufficient positioning signal is received in response to the query at decision block 1210. An insufficient signal may be a missing signal, a weak signal, a low accuracy signal, or an erroneous signal, for example.

When no position measurement is available (decision block 1210), the processor updates the stored dead zone information by storing information representative of the wireless networks in the environment of the mobile device 102 at or around the time that the unsuccessful position measurement attempt was made (Step 1212). This information can be used by the processor in future iterations of the method of FIG. 12 (e.g., when determining whether the mobile device 102 is in a positioning system dead zone, and thus a position measurement is unlikely to succeed, at Step 1208). For example, as discussed above with reference to Step 1208, the processor can store the information in the table 1550 of FIG. 15, which records a network identifier 1504 of the measurement, a time of the measurement 1506, and whether a first positioning system was available at that measurement (1508), among other things. In some implementations, the information stored at Step 1212 is the first measurement (received at Step 1202) or the second measurement (received at Step 1204). In some implementations, a new measurement representative of the wireless networks in the environment of the mobile device 102 is made after the processor determines that a position measurement is unavailable at decision block 1210, and that new measurement is stored at Step 1212.

In some embodiments, the processor stores information about more than one failed position measurement in a particular wireless network environment before the processor will stop attempting position measurements in that environment. Because the success of a measurement from a positioning system such as GPS can depend on many factors (including environmental conditions, temporary channel variations, and maintenance downtime), the processor can be configured to make a number of positioning attempts in a wireless network environment before determining that future positioning attempts in the wireless network environment will not be worthwhile. This number of failed attempts may be a fixed number (e.g., three) or further analysis may be triggered once a fixed number of failed attempts is recorded. For example, once three position measurements fail, the processor may look to a history of attempted position measurements to determine whether the majority of position measurements attempted in the network environment were failures; if yes, no future position measurements will be made in the network environment, but if no, additional attempts will be made in the future. In some embodiments, the processor resets the list of wireless network environments in which no positioning system is available (e.g., clearing the records in table 1550 of FIG. 15). The processor may reset the list periodically, in response to a user command, in response to changing conditions such as weather, or in response to detected changes in the built environment of the mobile device.

However, if the processor determines that a position measurement is available (decision block 1210), the processor proceeds to indicate that the mobile device is in motion at Step 1214. In parallel or in series with the indication at Step 1214, the processor returns to Step 1202 to receive another measurement of wireless networks in the environment of the mobile device 102. In some embodiments, the processor only makes one additional wireless network measurement before proceeding to decision block 1206, using the new wireless network measurement and the second measurement from the previous iteration of the technique of FIG. 12.

In some applications, the user of the mobile device 102 is not the only party responsible for the mobile device 102 or the user. Other responsible or interested parties include administrators, parents and employers. In some implementations, when the mobile device 102 exceeds a threshold speed, a notification is sent to one or more of these interested parties (or friends or business associates of the user of the mobile device 102). Such a message notifies the receiving party that the user is traveling, and should not be contacted. It may be in these parties' interests to confirm that any control hardware or software (as described herein) has not been tampered with or removed. In some implementations, the controller 104 of the mobile device 102 is configured to detect whether any settings or functions of the mobile device 102 have been tampered with. In particular, the controller 104 may be configured to process identifying information about a mobile device control application (such as the name, size of the file, associated properties and identification of an associated mobile device such as the mobile device 102). On a periodic or triggered basis, the controller 104 may receive a “check application” query from a network server or other device to determine whether the control application is still active on the device. This check may include verifying whether the application has the appropriate identifying information; if not, notification may be provided to at least one of the mobile device 102 or a device or electronic communications account associated with an interested party. The device or electronic communications account information (such as an e-mail address) may be stored in the MAP 123. In some implementations, the controller 104 detects that a control application has been tampered with when the control application fails to operate during a predetermined time period. For example, if the control application is a tracking application, and a position of the mobile device 102 has not been reported to the communications network 404 within the previous 24-hour period, a “check application” query would be transmitted by the communications network 404. Tamper detection and notification techniques may be performed by any suitable processor or system involved in the configuring, monitoring or control of the mobile device 102.

Additional mobile device control features that may be used with the techniques provided herein are described in the following provisional patent applications, incorporated herein in their entirety by reference: U.S. Provisional Patent Application No. 61/245,556, filed Sep. 24, 2009; U.S. Provisional Patent Application No. 61/245,799, filed Sep. 25, 2009; U.S. Provisional Patent Application No. 61/246,737, filed Sep. 29, 2009; U.S. Provisional Patent Application No. 61/245,815, filed Sep. 25, 2009; U.S. Provisional Patent Application No. 61/245,820, filed Sep. 25, 2009; U.S. Provisional Patent Application No. 61/245,891, filed Sep. 25, 2009; U.S. Provisional Patent Application No. 61/245,839, filed Sep. 25, 2009; U.S. Provisional Patent Application No. 61/245,900, filed Sep. 25, 2009; and U.S. Provisional Patent Application No. 61/246,587, filed Sep. 29, 2009.

It is to be understood that while various illustrative embodiments have been described, the forgoing description is merely illustrative and does not limit the scope of the invention. While several examples have been provided in the present disclosure, it should be understood that the disclosed systems, components, and methods may be embodied in many other specific forms without departing from the scope of the present disclosure.

What is claimed is:

1. A method for controlling a mobile device, comprising:
receiving a first accelerometer signal representative of motion of the mobile device;
determining, by the processor, a characteristic variation in the first accelerometer signal;
setting, by the processor, an acceleration threshold based at least in part on the characteristic variation;
comparing, by the processor, a second accelerometer signal to the acceleration threshold,
in response to the comparison indicating that the second accelerometer signal exceeds the acceleration threshold,
measuring a position of the mobile device using a positioning system;
determining, by the processor, whether a user of the mobile device is likely in control of a vehicle; and
in response to determining that the user is likely in control of a vehicle, disabling, by the processor, one or more mobile device features.

2. The method of claim 1, wherein receiving the first accelerometer signal comprises receiving a plurality of discrete accelerometer signals at approximately periodic points in time.

3. The method of claim 1, wherein determining a characteristic variation in the accelerometer signals comprises calculating a deviation from a central value of the accelerometer signals.

4. The method of claim 3, wherein the central value is a mean.

5. The method of claim 1, further comprising:
identifying, by the processor, one or more portions of the first accelerometer signal that are determined to have smaller variations than other portions of the first accelerometer signal,
wherein determining a characteristic variation in the first accelerometer signal comprises determining a characteristic variation in the identified one or more portions of the first accelerometer signal that are determined to have smaller variations.

6. The method of claim 1, wherein an absolute value of the acceleration threshold is greater than or equal to the characteristic variation.

7. The method of claim 1, wherein an absolute value of the acceleration threshold is less than or equal to a maximum of an absolute value of a small variation portion of the first accelerometer signal.

8. The method of claim 1, wherein determining the characteristic variation comprises analyzing portions of the first accelerometer signal received when the mobile device is not traveling in a vehicle.

9. The method of claim 1, wherein setting the acceleration threshold comprises analyzing portions of the first accelerometer signal received when the mobile device is traveling in a vehicle.

10. The method of claim 1, wherein the positioning system is a GPS system.

11. The method of claim 1, further comprising:
in response to the comparison indicating that the second accelerometer signal does not exceed the acceleration threshold,
enabling, by the processor, one or more features of the mobile device.

12. The method of claim 1, wherein comparing the second accelerometer signal to the acceleration threshold comprises comparing the absolute value of the second accelerometer signal to the absolute value of the acceleration threshold.

13. The method of claim 1, wherein setting the acceleration threshold comprises:
receiving a plurality of acceleration signals over two or more days;
identifying, by the processor, a pattern within the plurality of acceleration signals received over two or more days; and
selecting, by the processor, a value for the acceleration threshold based at least in part on the identified pattern.

14. The method of claim 1, wherein the second accelerometer signal is a portion of the first accelerometer signal.

15. The method of claim 1, wherein determining whether a user of the mobile device is likely in control of a vehicle is based at least in part on the measured position.

16. The method of claim 15, wherein determining whether a user of the mobile device is likely in control of a vehicle comprises determining that the mobile device has traveled beyond a predetermined distance in a particular amount of time.

17. The method of claim 1, wherein determining whether a user of the mobile device is likely in control of a vehicle comprises comparing a speed of the mobile device to a speed threshold.

18. The method of claim 1, wherein determining whether a user of the mobile device is likely in control of a vehicle comprises detecting a signal from a vehicle.

19. A method for controlling a mobile device, comprising:
receiving an accelerometer signal representative of the motion of the mobile device;
comparing, by the processor, the accelerometer signal to an acceleration threshold, wherein the acceleration threshold is stored in a memory;
in response to the comparison indicating that the accelerometer signal exceeds the acceleration threshold,
measuring a position of the mobile device using a positioning system;
determining, by the processor, whether a user of the mobile device is likely in control of a vehicle, based at least in part on the measured position; and
in response to determining that the user is likely in control of a vehicle, disabling, by the processor, one or more mobile device features.

20. A system for controlling a mobile device, comprising:
a control unit configured to:
receive a first accelerometer signal representative of motion of the mobile device;
determine a characteristic variation in the first accelerometer signal;
set an acceleration threshold based at least in part on the characteristic variation;
compare a second accelerometer signal to the acceleration threshold,
in response to the comparison indicating that the second accelerometer signal exceeds the acceleration threshold,
measure a position of the mobile device using a positioning system;
determine whether a user of the mobile device is likely in control of a vehicle; and
in response to determining that the user is likely in control of a vehicle, disable one or more mobile device features.

21. The system of claim 20, wherein receiving the first accelerometer signal comprises receiving a plurality of discrete accelerometer signals at approximately periodic points in time.

22. The system of claim 20, wherein determining a characteristic variation in the accelerometer signals comprises calculating a deviation from a central value of the accelerometer signals.

23. The system of claim 22, wherein the central value is a mean.

24. The system of claim 20, wherein the control unit is further configured to:
identify one or more portions of the first accelerometer signal that are determined to have smaller variations than other portions of the first accelerometer signal,
wherein determining a characteristic variation in the first accelerometer signal comprises determining a characteristic variation in the identified one or more portions of the first accelerometer signal that are determined to have smaller variations.

25. The system of claim 20, wherein an absolute value of the acceleration threshold is greater than or equal to the characteristic variation.

26. The system of claim 20, wherein an absolute value of the acceleration threshold is less than or equal to a maximum of an absolute value of a small variation portion of the first accelerometer signal.

27. The system of claim 20, wherein determining the characteristic variation comprises analyzing portions of the first accelerometer signal received when the mobile device is not traveling in a vehicle.

28. The system of claim 20, wherein setting the acceleration threshold comprises analyzing portions of the first accelerometer signal received when the mobile device is traveling in a vehicle.

29. The system of claim 20, wherein the positioning system is a GPS system.

30. The system of claim 20, wherein the control unit is further configured to:
in response to the comparison indicating that the second accelerometer signal does not exceed the acceleration threshold,
enable one or more features of the mobile device.

31. The system of claim 20, wherein comparing the second accelerometer signal to the acceleration threshold comprises comparing the absolute value of the second accelerometer signal to the absolute value of the acceleration threshold.

32. The system of claim 20, wherein setting the acceleration threshold comprises:
receiving a plurality of acceleration signals over two or more days;
identifying a pattern within the plurality of acceleration signals received over two or more days; and
selecting a value for the acceleration threshold based at least in part on the identified pattern.

33. The system of claim 20, wherein the second accelerometer signal is a portion of the first accelerometer signal.

34. The system of claim 20, wherein determining whether a user of the mobile device is likely in control of a vehicle is based at least in part on the measured position.

35. The system of claim 34, wherein determining whether a user of the mobile device is likely in control of a vehicle comprises determining that the mobile device has traveled beyond a predetermined distance in a particular amount of time.

36. The system of claim 20, wherein determining whether a user of the mobile device is likely in control of a vehicle comprises comparing a speed of the mobile device to a speed threshold.

37. The system of claim 20, wherein determining whether a user of the mobile device is likely in control of a vehicle comprises detecting a signal from a vehicle.

38. A system for controlling a mobile device, comprising:
a control unit configured to:
receive an accelerometer signal representative of the motion of the mobile device;
compare the accelerometer signal to an acceleration threshold, wherein the acceleration threshold is stored in a memory;
in response to the comparison indicating that the accelerometer signal exceeds the acceleration threshold,
measure a position of the mobile device using a positioning system;
determine whether a user of the mobile device is likely in control of a vehicle, based at least in part on the measured position; and
in response to determining that the user is likely in control of a vehicle, disable one or more mobile device features.
